(19) United States
(12) Patent Application Publication
(10) Pub. No.: US 2014/0124479 A1
(43) Pub. Date: May 8, 2014

(54) METHOD OF REMOVING COATING FILM OF SUBSTRATE PERIPHERAL PORTION, SUBSTRATE PROCESSING APPARATUS AND NON-TRANSITORY STORAGE MEDIUM

(71) Applicant: TOKYO ELECTRON LIMITED, Tokyo (JP)

(72) Inventors: Hiroshi TOMITA, Koshi City (JP); Kazuya HISANO, Koshi City (JP)

(73) Assignee: TOKYO ELECTRON LIMITED, Tokyo (JP)

(21) Appl. No.: 14/069,463

(22) Filed: Nov. 1, 2013

(30) Foreign Application Priority Data
Nov. 6, 2012 (JP) 2012-244310

(51) Int. Cl. B05B 15/04

(52) U.S. Cl. CPC B05B 15/0406
USPC 216/85; 156/345.17

(57) ABSTRACT

A method of removing a coating film of a substrate peripheral portion, is provided with holding and supporting a circular substrate by allowing a transfer body to transfer a rear surface of the substrate to a supporting part; removing a coating film in the shape of a ring by a predetermined width size by supplying a solvent from a solvent nozzle to a peripheral portion of the coating film formed on the surface of the substrate; transferring the substrate to an inspection module for inspecting a state of the coating film by imaging the entire surface of the substrate; detecting a removal region of the coating film based on image data acquired by the inspection module; and correcting a delivery position of a succeeding substrate with respect to the supporting part by the transfer body based on the detection result of the removal region of the coating film.

### CROSS-REFERENCE TO RELATED APPLICATION

This application claims the benefit of Japanese Patent Application No. 2012-244310, filed on Nov. 6, 2012, in the Japan Patent Office, the disclosure of which is incorporated herein in its entirety by reference.

### TECHNICAL FIELD

The present disclosure relates to a technique for removing an unnecessary peripheral portion from a coating film formed on a surface of a circular substrate.

### BACKGROUND

In a process of manufacturing semiconductor device chips, a coating film is formed on a surface of a wafer that is a circular substrate. The coating film includes a resist film, for example. The resist film forming process is performed by a substrate processing apparatus, which includes, e.g., a plurality of resist film forming modules and one or a plurality of transfer mechanisms for transferring substrates between the respective resist film forming modules. In the resist film forming modules, the resist is applied to the entire surface of the wafer, for example, by spin coating.

When the transfer mechanism transfers a wafer, the resist film formed on the peripheral portion of the wafer may come into contact with the transfer mechanism and thus may be a cause of particle generation. Accordingly, in the resist film forming module, the resist film on the peripheral portion of the wafer is to be removed in the form of a ring as an unnecessary portion. That is, the portion located further toward the center of the wafer than the unnecessary portion being removed is set as a semiconductor device forming region. Removal of the unnecessary portion can be performed by supplying a solvent, for the resist film, to the peripheral portion of the wafer, when the wafer rotates about an axis at a right angle to the wafer, while the center of the rear surface of a wafer is held and supported by the spin chuck used in the spin coating.

The size of the chip has been gradually decreasing and there has been some demand to produce as many chips as possible in one sheet (wafer) to increase production of the chips. If the resist film belonging to the semiconductor device forming region is removed, the semiconductor devices produced from the semiconductor device forming region from which the resist film is removed may become defective. Thus, in order to satisfy the demand, it is required to accurately remove the unnecessary portion. Specifically, it is necessary to align the center of the wafer with the center of the resist film from which the unnecessary portion is removed. Therefore, a transfer mechanism is required to accurately deliver the wafer to the spin chuck, so that the rotational center of the spin chuck and the center of the wafer do not deviate from each other. In addition, it is also required to accurately adjust a position at which the solvent is ejected with respect to the peripheral portion of the wafer.

From the above-described circumstance, the following operation has been performed until now. The operator using the substrate processing apparatus described above, memorizes which wafer is processed in which resist film forming module. Thereafter, the wafer on which the removal of the unnecessary portion of the resist film has been performed is unloaded to the outside of the substrate processing apparatus, a removal width (cutting width) of the resist film is measured using a measurement device such as a microscope. Based on the measurement result, an ejection position of the solvent is corrected in the resist film forming module in which the wafer has been processed, and when the transfer mechanism delivers the wafer to the spin chuck of the resist film forming module, a delivery position of the transfer mechanism with respect to the spin chuck is corrected. Each amount of correction is calculated manually by the operator or using a predetermined calculation tool.

After the correction, the user memorizes which wafer is processed in which resist film forming module again, and the wafer that has been processed in the resist film forming module subjected to the correction is measured again by the measurement device to confirm whether or not the correction is proper.

However, in the above-described method, it takes time to unload the wafer to the outside of the apparatus. For example, it may take time to transfer the wafer since the measurement device is installed in a building positioned in a place other than the place where the substrate processing apparatus is installed, or a waiting time is necessary until the measurement because the measurement device is in use. Since the measurement takes time as described above, the correction is delayed, and defective wafers may be produced in large scale. Also, memorizing each wafer in association with the resist film forming module in which the wafer is processed, as described above, may be burdensome to the operator and in some cases, it is troublesome since the operator needs to make a note thereof

Although detection of the outer periphery of a substrate and control of the ejection position of the solvent based on the detection has been described, this method may not correct a deviation in the delivery position of the wafer with respect to the spin chuck by the transfer mechanism and is insufficient to enlarge a device forming region as much as possible. In addition, inspection performed using an inspection device has been used, but the above problems have not been addressed.

### SUMMARY

The present disclosure provides a technology for facilitating control of an apparatus for removing an unnecessary portion of a coating film in removing the unnecessary portion of the coating film in the shape of the ring from a peripheral portion of a circular substrate surface.

According to one embodiment of the present disclosure, provided is a method of removing a coating film of a substrate peripheral portion, including: holding and supporting a circular substrate by allowing a transfer body to transfer a rear surface of the substrate to a supporting part; removing a coating film in the shape of a ring by a predetermined width size by supplying a solvent from a solvent nozzle to a peripheral portion of the coating film formed on the surface of the substrate while rotating the supporting part around an axis normal to the substrate; transferring the substrate to an inspection module for inspecting a state of the coating film by imaging the entire surface of the substrate; detecting a removal region of the coating film based on image data acquired by the inspection module; and correcting a delivery position of a succeeding substrate with respect to the supporting part by the transfer body based on the detection result of the removal region of the coating film.

According to another embodiment of the present disclosure, provided is a method of removing a coating film of a substrate peripheral portion, including: holding and supporting a circular substrate by allowing a transfer body to transfer a rear surface of the substrate to a supporting part; removing a coating film in the shape of a ring by a predetermined width size by supplying a solvent from a solvent nozzle to a peripheral portion of the coating film formed on the surface of the substrate while rotating the supporting part around an axis normal to the substrate; transferring the substrate to an inspection module for inspecting a state of the coating film by imaging the entire surface of the substrate; detecting a removal region of the coating film based on image data acquired by the inspection module; and correcting an ejection position of the solvent to a succeeding substrate by the solvent nozzle based on the detection result.

According to another embodiment of the present disclosure, provided is a substrate processing apparatus, including: a coating film peripheral portion removing module including a rear surface supporting part configured to hold and support a rear surface of a circular substrate having a coating film formed on a surface thereof and to rotate the substrate around an axis normal to the substrate, and a solvent supply nozzle configured to remove the coating film in the shape of a ring by a predetermined width size by supplying a solvent to a peripheral portion of the rotating substrate; a transfer body configured to transfer the substrate to the coating film peripheral portion removing module by means of a driving mechanism and to deliver the substrate to the rear surface supporting part; an inspection module configured to acquire image data for inspecting a state of the coating film by imaging the entire surface of the substrate having the coating film removed; a data processing part configured to detect a removal region of the coating film based on the image data; and a transfer body operation part configured to operate the driving mechanism to correct a delivery position of a succeeding substrate with respect to the supporting part by the transfer body based on the removal region.

According to another embodiment of the present disclosure, provided is a substrate processing apparatus, including: a coating film peripheral portion removing module including a rear surface supporting part configured to hold and support a rear surface of a circular substrate having a coating film formed on a surface thereof and to rotate the substrate around an axis normal to the substrate, a solvent supply nozzle configured to remove the coating film in the shape of a ring by a predetermined width size by supplying a solvent to a peripheral portion of the rotating substrate, and a moving mechanism configured to move a supply position of the solvent between a circumferential end and an inside of the substrate; an inspection module configured to acquire image data for inspecting a state of the coating film by imaging the entire surface of the substrate having the coating film removed; a data processing part configured to detect a removal region of the coating film based on the image data; and a moving mechanism operation part configured to operate the moving mechanism to correct the supply position of the solvent by the moving mechanism based on the removal region.

According to another embodiment of the present disclosure, provided is a non-transitory storage medium for storing a computer program used in a substrate processing apparatus including a coating film peripheral portion removing module configured to remove a coating film of a peripheral portion of a circular substrate of a predetermined size and a transfer body configured to transfer the substrate to the coating film peripheral portion removing module, wherein the computer program performs the method according to the above-described embodiments.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a transverse cross sectional plan view of a coating and developing apparatus including resist film forming modules.

FIG. 2 is a perspective view of the coating and developing apparatus.

FIG. 3 is a longitudinal cross sectional side view of the coating and developing apparatus.

FIG. 4 is a perspective view of a unit block of the coating and developing apparatus.

FIG. 5 is a schematic side view of a direction adjusting module installed at the unit block.

FIG. 6 is a perspective view of the resist film forming module.

FIG. 7 is a longitudinal cross sectional side view of the resist film forming module.

FIG. 8 is a plan view of a transfer arm of the unit block.

FIG. 9 is a view illustrating the operation of the resist film forming module.

FIG. 10 is a view illustrating the operation of the resist film forming module.

FIG. 11 is a view illustrating the operation of the resist film forming module.

FIG. 12 is a view illustrating the operation of the resist film forming module.

FIG. 13 is a plan view of a wafer W having the resist film formed thereon.

FIG. 14 is a plan view of a transfer arm of the unit block.

FIG. 15 is a view illustrating a relationship between a wafer and a resist film.

FIGS. 16A and 16B are views illustrating an image data of a wafer.

FIGS. 17A to 17F are views illustrating a relationship between the image data and measurement groups.

FIG. 18 is a view illustrating a relationship between a wafer and a resist film.

FIG. 19 is a view illustrating a relationship between a wafer and a resist film.

FIG. 20 is a view illustrating a relationship between a wafer and a resist film.

FIG. 21 is a table showing an example of calculated parameters.

FIG. 22 is a view showing the configuration of a control unit installed at the coating and developing apparatus.

FIG. 23 is a flow chart showing a process of correcting a delivery position and a solvent processing position.

FIGS. 24A and 24B are views illustrating that the delivery position is changed.

FIGS. 25A and 25B are views illustrating that the solvent processing position is changed.

FIGS. 26A to 26C are views illustrating an example of display screens.

FIGS. 27A and 27B are graphs showing correction of a parameter.

FIG. 28 is a schematic side view of a resist film forming module.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### First Embodiment

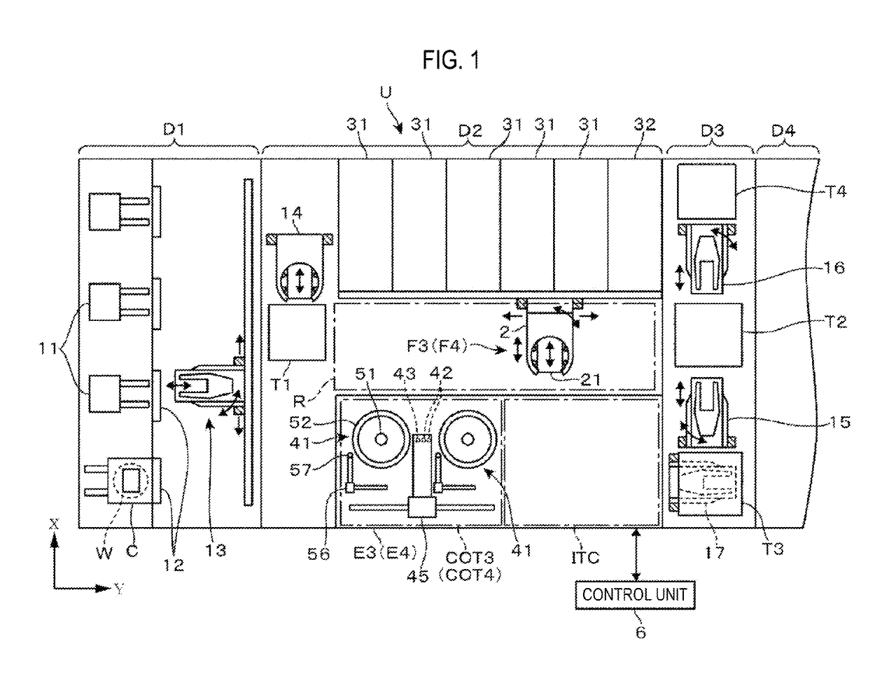

A coating and developing apparatus 1 as one embodiment of a substrate processing apparatus of the present disclosure will be described with reference to FIGS. 1 to 3, which are a plan view, a perspective view, and a schematic longitudinal cross sectional side view thereof, respectively. The coating and developing apparatus 1 is configured by linearly connecting a carrier block D1, a processing block D2, and an interface block D3 to one another. In the following descriptions, a direction along which the blocks D1 to D3 are arranged is referred to as a Y direction, and a horizontal direction perpendicular to the Y direction is referred to as an X direction. An exposure device D4 is connected to the interface block D3.

A carrier C storing therein a lot consisting of plural sheets of wafers W is transferred to the carrier block D1. The wafer W is of a circular substrate and has a notch N cut for indicating a direction of the wafer W at a periphery thereof. The carrier block D1 includes mounting tables 11 of the carriers C, opening/closing members 12, and a transfer and mounting mechanism 13 for transferring the wafer W from the carrier C through the opening/closing member 12.

The processing block D2 includes first to sixth unit blocks E1 to E6, which perform liquid treatment on the wafers W and are stacked in this order from the bottom side. In some cases, for convenience of description, a process of forming an anti-reflective film on a lower layer side of a wafer W is referred to as “BCT” a process of forming a resist film on a wafer W is referred to as “COT,” and a process of forming a resist pattern on a wafer W after exposure is referred to as “DEV”.

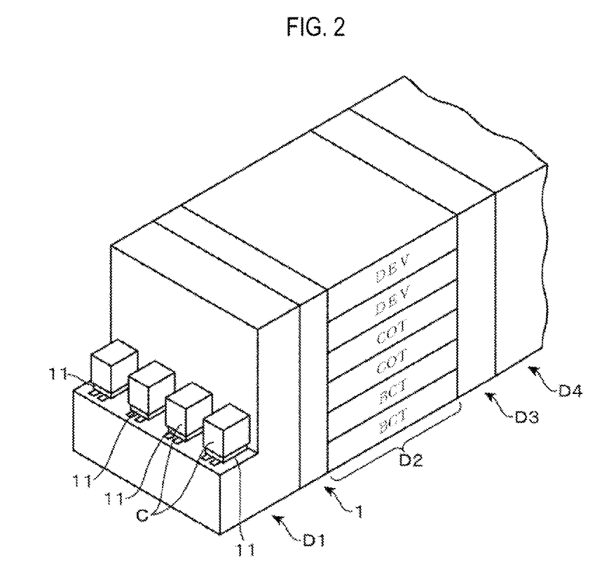

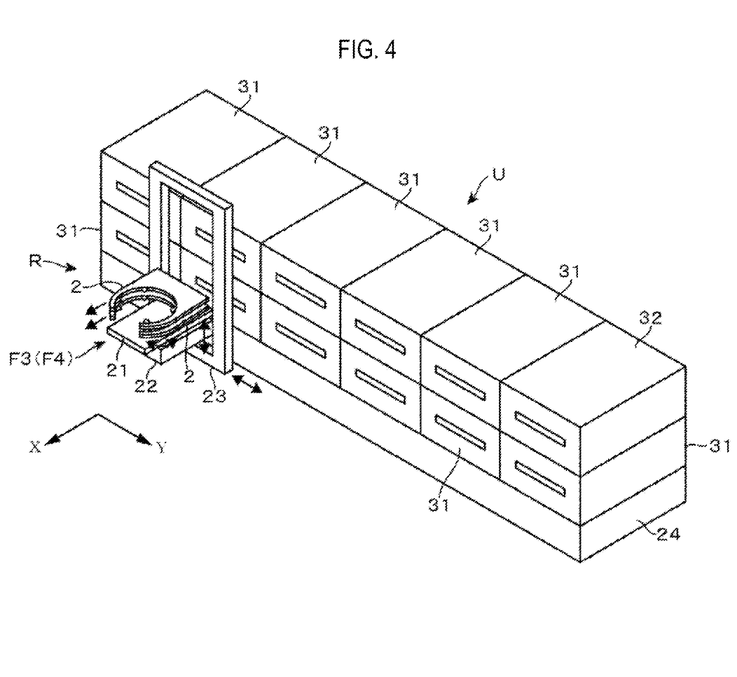

In this example, a pair of BCT floors, a pair of COT floors, and a pair of DEV floors are stacked in this order from the bottom side as shown in FIG. 2. In the same unit block, the wafers W are transferred and processed in parallel with each other. Here, the COT floors E3 and E4 having the same configuration will be described as an example with reference to FIG. 1. In addition, the description of the COT floors E3 and E4 will also refer to FIG. 4 which is a perspective view thereof. A shelf unit U is disposed in a Y-direction in one of the left and right sides of a transfer region R when viewed from the carrier block D1 to interface block D3, and resist film forming modules COT and protective film forming modules ITC each of which is a liquid treatment unit are arranged in the Y direction on the other side.

The resist film forming module COT is a module having therein a module for removing the coating film of the peripheral portion, and serves to supply the wafer W with a resist to form a resist film and to remove the unnecessary portion of the resist film in the peripheral portion of the wafer W. The resist film forming module COT will be described in detail later. Further, in the following descriptions, in order to distinguish the resist film forming modules of the COT floors E3 and E4 from each other, the resist film forming module of the unit block E3 is referred to as COT3, and the resist film forming module of the unit block E4 is referred to as COT4. The protective film forming module ITC is a module for supplying a predetermined treatment liquid onto the resist film to form a protective film for the resist film.

The transfer region R is provided with transfer arms F which are transfer mechanisms for the wafers W. The transfer arm of the unit block E3 is referred to as F3, and the transfer arm of the unit block E4 is referred to as F4. Each of the transfer arms F3 and F4 includes holding and supporting bodies 2 (transfer members) for holding and supporting the wafer W, a base 21, a lift table 22, a frame 23 and a housing 24. The holding and supporting bodies 2 are installed above the base 21 to overlap with each other in a vertical direction and independently advance and retreat above the base 21 horizontally. The holding and supporting body 2 holds and supports the wafer W by surrounding a side of the peripheral portion of the wafer W and also supporting the rear surface of the wafer W. In addition, the holding and supporting body 2 is provided with a suction port (not shown) for the wafer W, thereby preventing the wafer W from being misaligned on the holding and supporting body 2. Hereinafter, in some cases, the respective holding and supporting bodies 2 are distinguished into the upper holding and supporting body and the lower holding and supporting body in description. In drawings, the holding and supporting body 2 is indicated with “holder”. The base 21 is installed on the lift table 22 to rotate about the vertical axis. The lift table 22 is installed to be surrounded by the frame 23 extending in the up and down direction. The frame 23 is connected to the housing 24 positioned at a low side of the shelf unit U and moves in the Y direction within the transfer region R.

The base 21 is provided with a driving mechanism for advancing and retreating the holding and supporting bodies 2, and the lift table 22 is provided with a driving mechanism for rotating the base 21. The frame 23 is provided with a driving mechanism for lifting up and down the lift table 22, and the housing 24 is provided with a driving mechanism for moving the frame 23. Each driving mechanism includes a motor, a pulley, and a belt wound around the motor and the pulley. Through the belts, the rotational motion of each motor is converted into a linear motion, whereby the frame 23, the lift table 22, and the holding and supporting bodies 2 move. The rotation of the pulley causes the base 21 to rotate. Each motor is provided with an encoder to output a pulse number signal based on the rotational amount of the motor from a predetermined reference position to a control unit 6 of the coating and developing apparatus 1. That is, a pulse of the number corresponding to the position of each of the holding and supporting bodies 2, the base 21, the lift table 22 and the frame 23 is output from the encoder of each motor. For the transfer of the wafer W between the modules by the transfer arms F3 and F4, the control unit 6 outputs a control signal allowing each motor to have a predetermined pulse value. The control unit 6 is a computer for controlling the operation of the coating and developing apparatus 1, which will be described in detail later.

Returning to the description of the COT floors E3 and E4, the shelf unit U is provided with a heating module 31 and a direction adjusting module 32 for adjusting a direction of the wafer W. The heating module 31 has a hot plate for heating a wafer W.

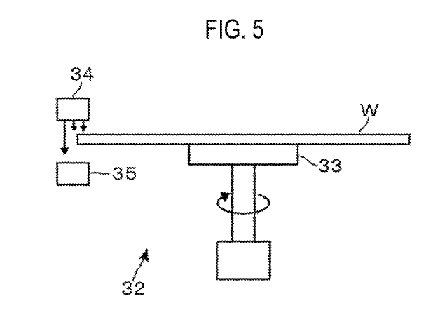

A schematic side view of the direction adjusting module 32 is shown in FIG. 5. In the drawing, reference numeral 33 designates a stage rotating the wafer W loaded on its surface about the vertical axis. Reference numeral 34 designates a light projection unit, which projects light to the peripheral portion of the rotating wafer W. Reference numeral 35 designates a light reception unit, which receives the light projected from the light projection unit 34. Based on a change in a region supplied with the light in the light reception unit 35, the control unit 6 detects the notch N. After the notch N is detected, in a state where the notch N faces a predetermined direction by the stage 33, the transfer arm F3 or F4 picks up the wafer W from the stage 33. The direction adjusting module 32 is a periphery exposure module having a light source for exposing the periphery of the wafer W, which is to remove the exposed peripheral portion during the development. In this example, since the removal of the peripheral portion is performed by the resist film forming module COT and the periphery exposure is not performed, the light source is omitted from the drawings.

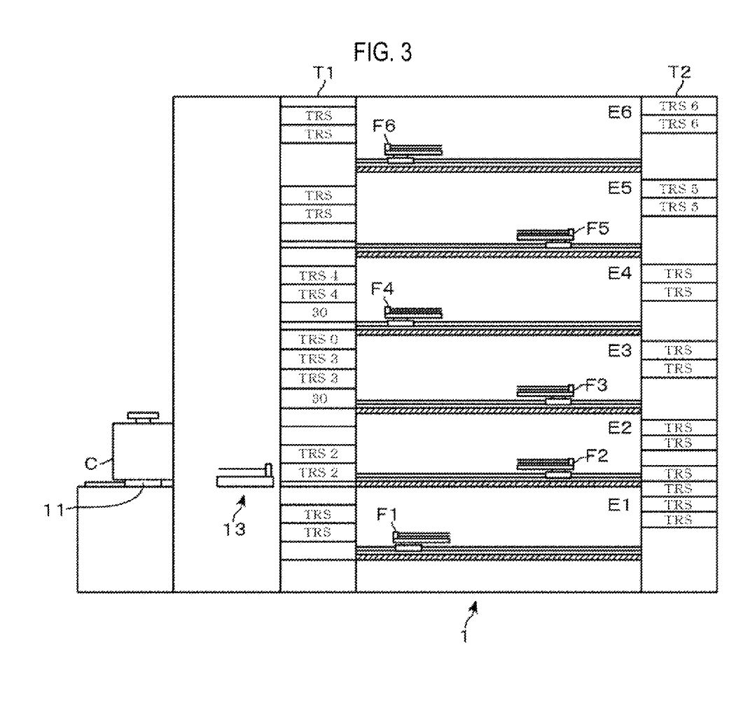

Each of the other unit blocks E1, E2, E5 and E6 has the same configuration as the unit block E3 or E4 except that different liquid chemicals are supplied to the wafer W, the heating module 31 is installed instead of the direction adjusting module 32, and the like. The unit block E1 or E2 is provided with an anti-reflective film forming module instead of the resist film forming module COT3 or COT4. The unit block E5 or E6 is provided with a developing module. In FIG. 3, the transfer arms of the unit blocks E1 to E6 are shown as F1 to F6, respectively.

A tower T1 vertically extending over the respective unit blocks E1 to E6 and a transfer arm 14 that is a vertically movable transfer mechanism for delivering a wafer W to the tower T1 are installed in the side of the processing block D2 facing the carrier block D1. The tower T1 is configured with a plurality of modules stacked on one another and the modules are installed at the respective levels of the unit blocks E1 to E6, so that a wafer W may be delivered between the modules and the respective transfer arms F1 to F6 of the unit blocks E1 to E6. The modules include transfer modules TRS installed at the levels of the respective unit blocks, temperature adjustment modules CPL for adjusting the temperature of wafers W, buffer modules for temporarily storing a plurality of wafers W, hydrophobization processing modules for making surfaces of wafers W hydrophobic, and the like. For simplicity of description, depictions of the hydrophobization processing modules, the temperature adjustment modules, and the buffer modules are omitted.

In addition, the tower T1 is provided with an inspection module (image acquisition module) 30, and the wafer W on which a resist film is formed in the resist film forming module COT is loaded into the inspection module 30. The inspection module 30 has a stage on which the wafer W is mounted and a camera for imaging the surface of the wafer W mounted on the stage, and an image data of the surface of the wafer W picked up by the camera is transmitted to the control unit 6. As described later, the control unit 6 detects a cutting width of a resist film based on the image data and also determines whether a surface state of the resist film is good or defective based on the image data. Whether the surface state is good or defective is determined by examining, for example, whether or not the number of particles is equal to or less than a predetermined number and whether or not there is a place on which no resist film is formed except the peripheral portion of the wafer W.

The interface block D3 includes towers T2, T3 and T4, each of which vertically extends over the unit blocks E1 to E6, and is provided with an interface arm 15 that is a vertically movable transfer mechanism for delivering the wafer W to the tower T2 and the tower T3, an interface arm 16 that is a vertically movable transfer mechanism for delivering a wafer W to the tower T2 and the tower T4, and an interface arm 17 for delivering a wafer W between the tower T2 and the exposure device D4. The tower T2 is configured such that the transfer modules TRS, buffer modules for storing and holding plural sheets of wafers W before exposure processing, buffer modules for storing plural sheets of wafers W after exposure processing, temperature adjustment modules for adjusting the temperature of wafers W and the like are stacked on one another, wherein only the transfer modules TRS are depicted. In addition, although each of the towers T3 and T4 is provided with modules, the description thereof will be omitted herein.

A transfer path of the wafer W in the system including the coating and developing apparatus 1 and the exposure device D4 will be described. The wafer W is unloaded from a carrier C for each lot. That is, once all wafers W of one lot are unloaded, the wafers W of another lot are unloaded from the carrier C. In addition, before each wafer W is unloaded from the carrier C, the transfer path of the wafer W is set in advance, so that the wafer is transferred to a predetermined unit block among the above-described doubled unit blocks. Also, when there are a plurality of modules of the same type, the wafer W is transferred to a predetermined module among them.

The wafer W is transferred from the carrier C to a transfer module TRS0 of the tower T1 in the processing block D2 by means of the transfer and mounting mechanism 13. The wafers W from the transfer module TRS0 are distributed and transferred to the unit blocks E1 and E2.

For example, when the wafer W is delivered to the unit block E1, the wafer W is delivered from the transfer module TRS0 to a transfer module TRS1 (a transfer module capable of delivering the wafer W by the transfer arm F1) corresponding to the unit block E1 among the transfer modules TRS of the tower T1. Also, when the wafer W is delivered to the unit block E2, the wafer W is delivered from the transfer module TRS0 to a transfer module TRS2 corresponding to the unit block E2 among the transfer modules TRS of the tower T1. The delivery of these wafers W are achieved by means of the transfer arm 14.

The wafers W distributed as described above are transferred in the following sequence: the transfer module TRS1 (TRS2)→the anti-reflective film forming module→the heating module 31→the transfer module TRS 1 (TRS2). After that, the wafers W are distributed to a transfer module TRS3 corresponding to the unit block E3 and a transfer module TRS4 corresponding to the unit block E4 by the transfer arm 14.

The wafers W distributed to the transfer modules TRS3 and TRS4 as described above are transferred in the following sequence: the transfer module TRS3 (TRS4)→the direction adjusting module 32→the resist film forming module COT3 (COT4)→the heating module 31→the inspection module 30→the protective film forming module ITC→the heating module 31→the transfer module TRS of the tower T2, and are then loaded in the exposure device D4 through the tower T3. The wafers W after the exposure processing are transferred between the towers T2 and T4, and respectively transferred to transfer modules TRS5 and TRS6 of the tower T2 corresponding to the unit blocks E5 and E6. Thereafter, the wafers are transferred in the following sequence: the heating module 31→the developing module→the heating module 31→the transfer module TRS of the tower T1 and then, return to the carrier C through the transfer and mounting mechanism 13.

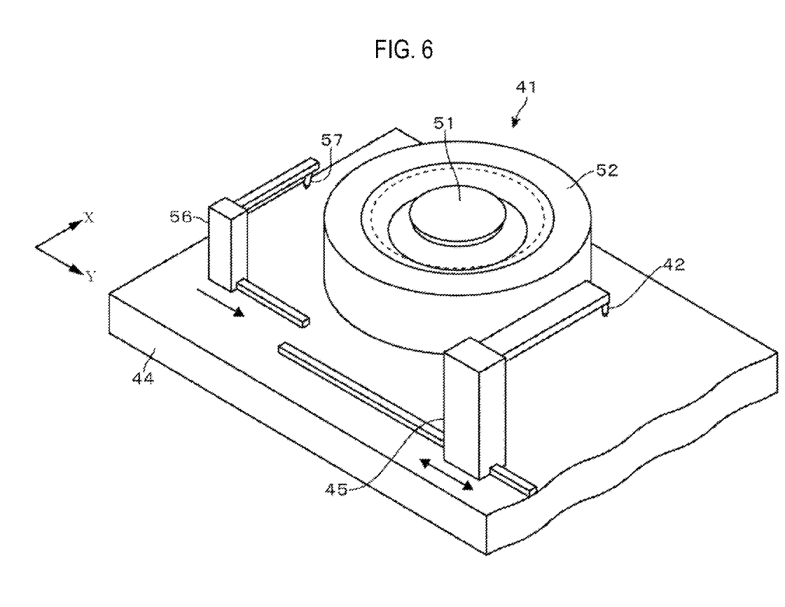

Subsequently, the resist film forming modules COT3 and COT4 will be described. These resist film forming modules COT3 and COT4 have the same configuration and herein the resist film forming module COT3 will be described as an example with reference to a perspective view of FIG. 6. The resist film forming module COT3 has two processing units 41, a plurality of resist supply nozzles 42 (for convenience for description, only one of them being shown in FIG. 6, and only two of them being shown in FIG. 1), and a solvent supply nozzle 43. These nozzles 42 and 43 are used in the processing units 41 together and movable on the base 44 by means of a moving part 45 so that they can be positioned above wafers W of the respective processing units 41. FIG. 6 shows only one of the processing units 41. Hereinafter, description will be made on only one of the processing units 41 for the convenience of description.

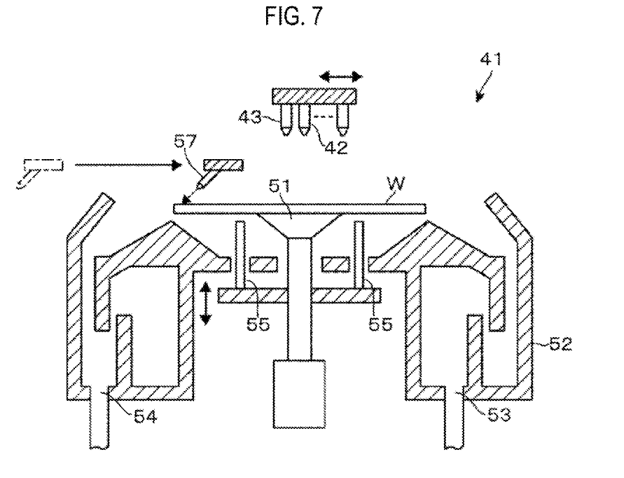

The processing unit 41 has a spin chuck 51, which is a substrate holding part for suction-holding and supporting a rear surface of a wafer W, and a cup 52 surrounding the spin chuck 51 and having an open upper side. FIG. 7 is a longitudinal cross sectional side view of the cup 52. In the figure, reference numeral 53 designates an exhaust port for exhausting the inside of the cup 52, and reference numeral 54 designates a waste liquid port. Reference numeral 55 designates lift pins, three of which are installed to deliver a wafer W between the spin chuck 51 and the transfer arm F3. In the figure, only two of them are depicted.

In FIG. 6, reference numeral 56 designates a moving part. The moving part 56 is provided with a peripheral portion solvent supply nozzle 57. The base 44 is provided with a driving mechanism for moving the moving part 56. The driving mechanism includes a motor, a pulley and a belt in the same way as the driving mechanism provided at the transfer arm F. The moving part 56 allows the peripheral portion solvent supply nozzle 57 to horizontally move in the Y direction, whereby an ejection position of solvent may be moved between the circumferential end and the central portion of a wafer W. The motor of the moving part 56 also outputs a pulse number signal according to the rotation amount from a reference position in the same way as the motor of the transfer arm F. The control unit 6 outputs a control signal allowing the pulse number to become a predetermined value, thereby locating the peripheral portion solvent supply nozzle 57 at a predetermined position. The position where the peripheral portion solvent supply nozzle 57 ejects the solvent is referred to as a solvent processing position, and the position where a solvent is ejected on the periphery of a wafer W from the nozzle 57 is referred to as a solvent ejection position.

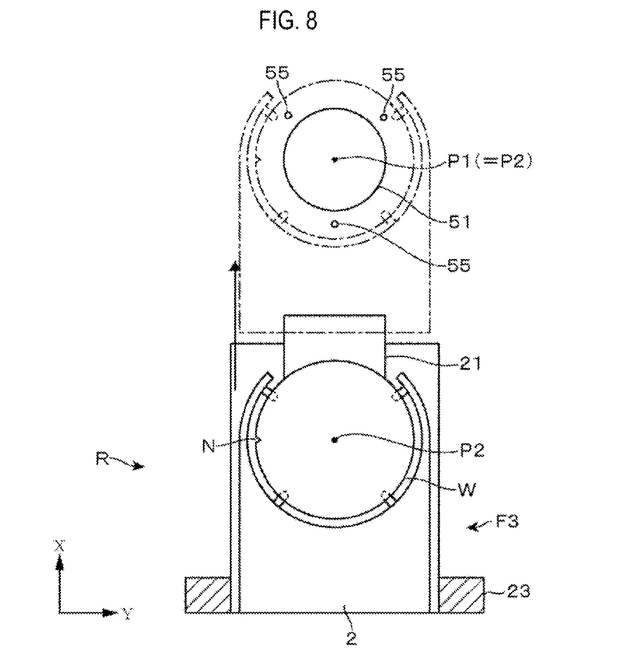

Referring to FIGS. 8 to 12, the delivery of a wafer W from the transfer arm F3 to the resist film forming module COT3 and the processing of the wafer W in the resist film forming module COT3 will be described. First, the holding and supporting body 2 of the transfer arm F3 picks up the wafer W from the stage 33 of the direction adjusting module 32, and the transfer arm F3 moves within the transfer region R in the Y direction. Accordingly, the holding and supporting body 2 moves to the front of the spin chuck 51 while the base 21 rotates, and as shown in a solid line in FIG. 8, the holding and supporting body 2 is positioned in the front of the spin chuck 51 to face the spin chuck 51. Then, the holding and supporting body 2 advances over the base 21 in the X direction, and as shown in a dot-dashed line in FIG. 8, the wafer W is transferred to a delivery position of the spin chuck 51. Thereafter, the wafer W is supported by the raised lift pins 55, the holding and supporting body 2 is retreated, and then, the lift pins 55 are lowered, whereby the wafer W is delivered to the spin chuck 51.

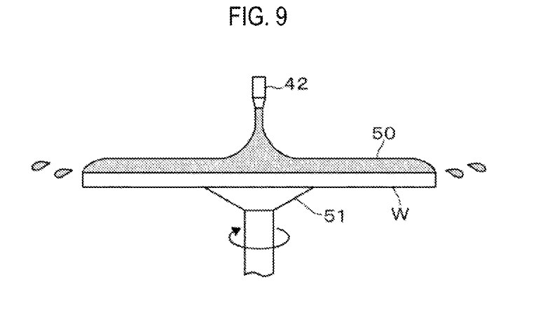

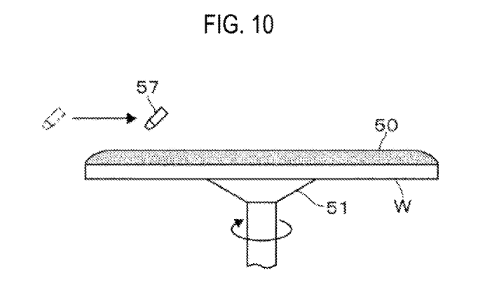

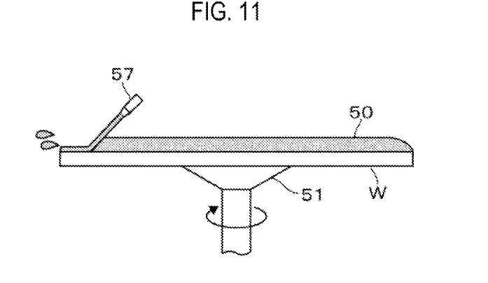

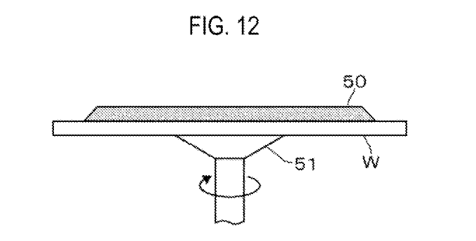

The wafer W is rotated by the spin chuck 51, and thinner is ejected to the central portion of the wafer W from the solvent supply nozzle 43 and is spread on the peripheral portion of the wafer W by the centrifugal force. So-called spin coating is performed. Next, a resist is supplied to the central portion of the wafer W from the resist supply nozzles 42, and a resist film 50 is formed on the entire surface of the wafer W by spin coating (see FIG. 9). Thereafter, the peripheral portion solvent supply nozzle 57 moves from a standby position outside the cup 52 to the solvent processing position in the cup 52 (see FIG. 10), to eject the solvent to the peripheral portion of the rotating wafer W. The solvent is spread from the solvent ejection position to the circumferential end of the wafer W by the centrifugal force, whereby an unnecessary portion of the peripheral portion of the wafer W is removed in the shape of a ring (see FIG. 11). If the processing is terminated by stopping the supply of the solvent and the rotation of the wafer W (see FIG. 12), the wafer W is unloaded from the resist film forming module COT by means of the transfer arm F3.

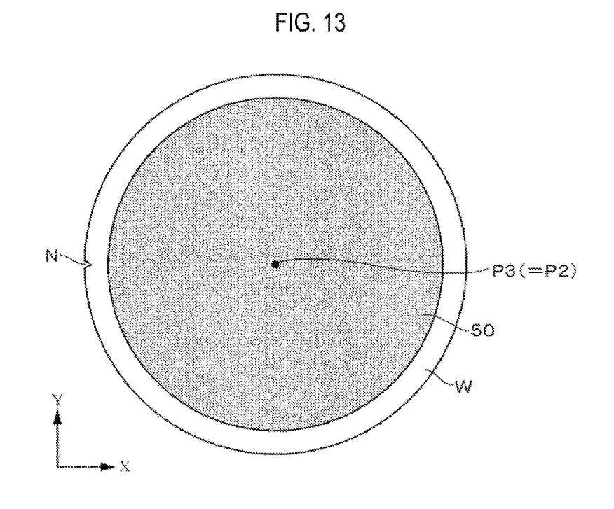

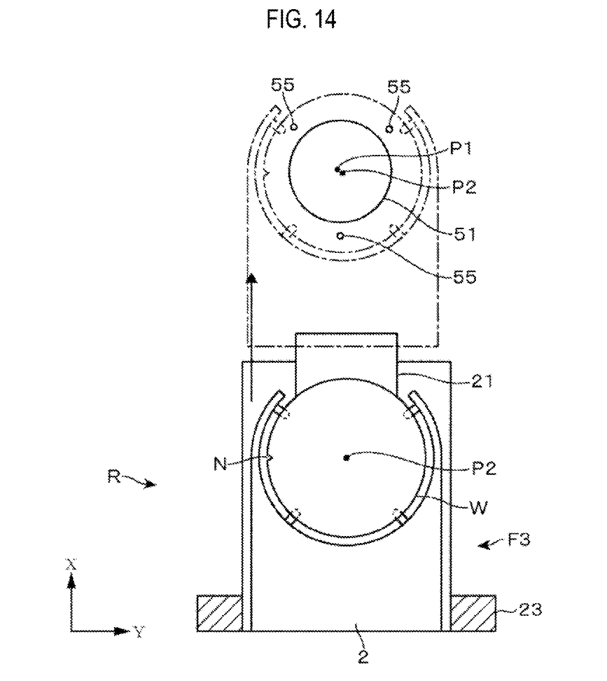

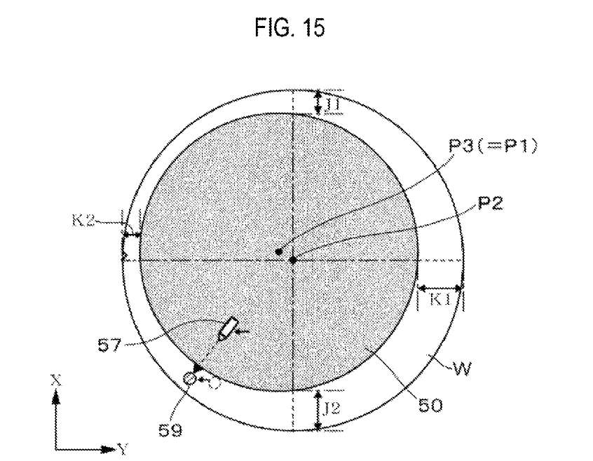

Here, the delivery position of the wafer W with respect to the spin chuck 51 is in a position where a rotational center P1 of the spin chuck 51 coincides with a center P2 of the wafer W as shown in FIG. 8. As described above, if the rotational center P1 coincides with the center P2 of the wafer W, a center P3 of the resist film 50 having the unnecessary portion removed coincides with the center P2 of the wafer W as shown in FIG. 13. However, because of aging degradation of the transfer arm F3, in some cases, looseness of the belt of each driving mechanism or tooth jumping of the belt may occur. When these troubles are generated, if the holding and supporting body 2 is moved to a position where pulses are output from each encoder in the same way as when the holding and supporting body 2 is located at the delivery position of FIG. 8, the rotational center P1 may not coincide with the center P2 of the wafer W, for example, as shown in FIG. 14. That is, the delivery position of the wafer W is offset with respect to the spin chuck 51. In this case, as shown in FIG. 15, the center P3 of the resist film 50 is eccentric from the center P2 of wafer W.

The coating and developing apparatus 1 is configured so that such an eccentricity is detected and the film may be formed for the eccentricity not to occur in the subsequent wafers W. This method will be schematically described with reference to FIG. 15. In description, the diameters of a wafer W in the X and Y directions when the wafer W is delivered to the spin chuck 51 at the delivery position are referred to as X and Y axes of the wafer W, respectively.

Based on the image data obtained from the inspection module 30, at both ends of the X axis, cutting widths (removal widths of the resist film) J1 and J2, each of which is a distance between the circumferential end of the wafer W and the circumferential end of the resist film 50, are respectively detected. In addition, based on the image data, at both ends of the Y axis, cutting widths K1 and K2, each of which is a distance between the circumferential end of the wafer W and the circumferential end of the resist film 50, are respectively detected. Then, ΔX=(J1−J2)/2 and ΔY=(K1−K2)/2 are calculated. The delivery position of the transfer arm F3 is made to be offset in the X and Y directions by the calculated ΔX and ΔY, respectively. For example, if the K1 is 0.6 mm and K2 is 0.4 mm, the delivery position to the spin chuck 51 is made to be offset by ΔY=(0.6 [mm]−0.4 [mm])/2=0.1 mm from the predetermined position.

For easy understanding, although mm is used as a unit of the correction amount ΔX or ΔY, since the delivery position of the holding and supporting body 2 is set as a pulse value of the encoder by the control unit 6 as described above, the correction amount ΔX or ΔY is practically represented in a pulse value. More specifically, when the holding and supporting body 2 is located at the above delivery position, a pulse value (a pulse value in the X direction) of the motor installed on the base 21 for moving the holding and supporting body 2 in the X direction and a pulse value (a pulse value in the Y direction) of the motor installed to the housing 24 for moving the holding and supporting body 2 in the Y direction, such as 3000 pulses and 2000 pulses, are stored in the control unit 6, respectively.

As a result of detecting the cutting widths as described above by acquiring the image data for the wafer W delivered and processed in the delivery position in the inspection module 30, let's suppose that ΔX is equivalent to −30 pulses and ΔY is equivalent to 10 pulses. The control unit 6 corrects the delivery position to be offset by ΔX and ΔY and stores the pulse value of the delivery position in the X direction as 3000−(−30)=3030 and the pulse value in the Y direction as 2000−10=1990. Then, the succeeding wafer W is transferred to a newly set delivery position in which these pulse values are output, thereby preventing the eccentricity of the center P2 of the wafer W with respect to the rotational center P1 of the spin chuck 51.

In more detail, the direction adjusting module 32 allows the wafer W to face a predetermined direction. While the wafer W is held and supported by the transfer arm F3 and also loaded in the heating module 31 after the resist film is formed, the direction of the wafer W is not changed. In addition, after the wafer W is delivered to the spin chuck 51, the rotation amount of the wafer W until the rotation of the spin chuck 51 stops due to the termination of the process in the module is controlled to be a predetermined value by the control unit 6. That is, the wafer W may be transferred to the resist film forming module COT3 and the inspection module 30 in a predetermined direction. Therefore, after being processed in the resist film forming module COT3, the wafer W may be transferred to the inspection module 30 in the predetermined direction, so that an image data of the wafer W in the predetermined direction can be picked up in the inspection module 30. In this manner, the correction amount ΔX and the correction amount ΔY can be calculated as described above.

The delivery position of the transfer arm F4 is also adjusted in the same way as the transfer arm F3. In addition, the correction of the solvent processing position of the peripheral portion solvent supply nozzle 57 is performed almost in the same way as the transfer arms F3 and F4. That is, in the solvent ejection, the nozzle 57 is moved based on a predetermined pulse value of the encoder of the motor driving the nozzle 57. The control unit 6 calculates an average of the cutting widths J1, J2, K1 and K2 based on the image data, obtains a difference between the calculated value and a predetermined cutting width target value, and corrects the solvent processing position by the amount corresponding to the difference. As a result of the correction of the solvent processing position, the solvent ejection position 59 on the wafer W is changed as shown in FIG. 15, which becomes the target value of the cutting width. The solvent ejection position 59 is a projection region of an ejection port of the nozzle 57.

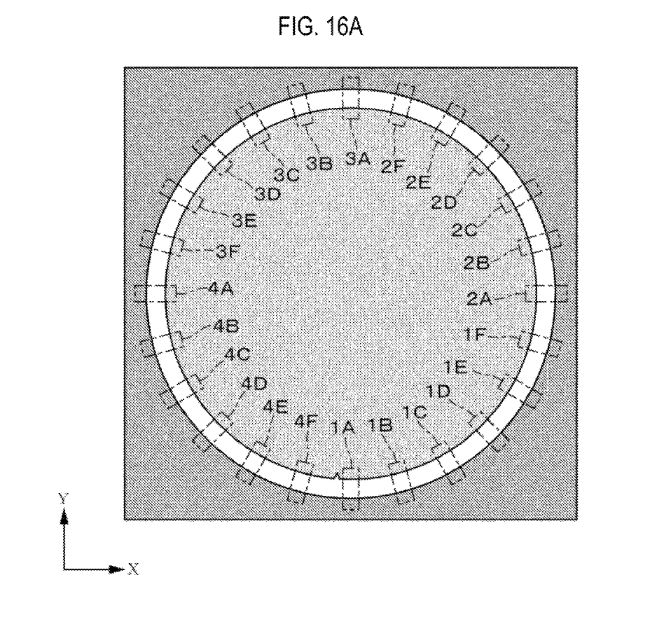

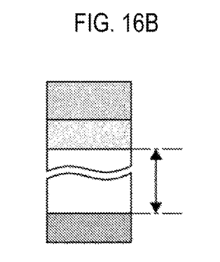

Heretofore, for the convenience of description, it has been described that the cutting widths are measured at four locations in the image data of the wafer W. However, in practice, the cutting widths are measured, for example, at 24 regions spaced apart from one another in the circumferential direction of the wafer W. FIG. 16A shows an example of image data of a wafer W and measurement regions surrounded by dot-dashed lines, respectively. Each measurement region has a rectangular shape at the peripheral portion of the wafer W, which extends from the central portion side toward the outer circumference of the wafer. In the image data, a gray level of the image is changed at a boundary between the resist film 50 and a region having the resist film removed and a boundary between the inside and the outside of the wafer W, and based on the change of the gray level, the control unit 6 detects the cutting width of the resist film 50. In FIG. 16B, the measurement region designated by reference numeral 1A in FIG. 16A is magnified to show the cutting width with an arrow.

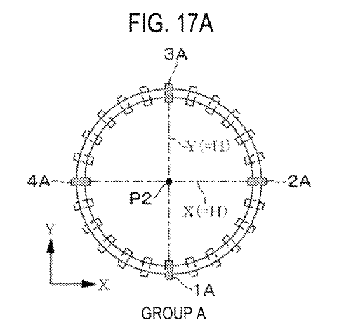

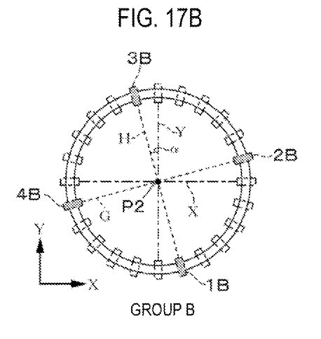

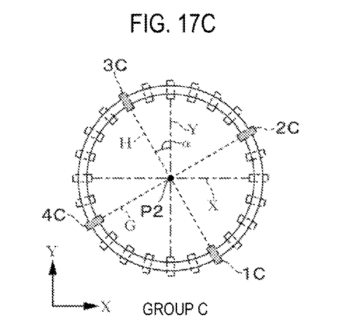

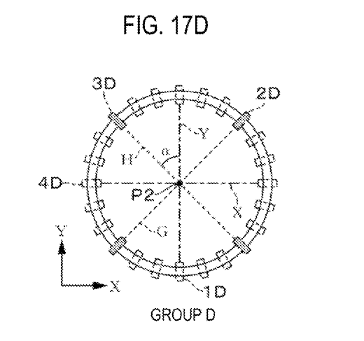

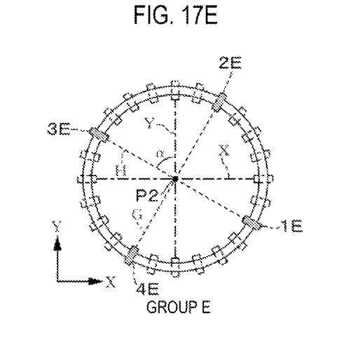

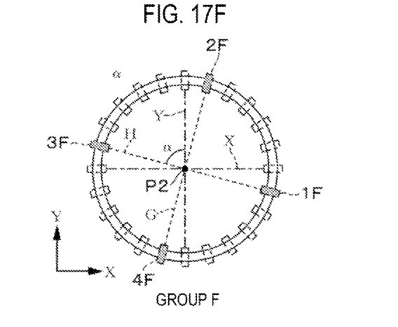

The respective measurement regions will be described with reference to FIGS. 17A to 17F. For example, four of the 24 measurement regions are set to overlap with the X and Y axes of the wafer W. Referring to FIG. 17A, the four measurement regions are defined as group A and shown as measurement regions 1A, 2A, 3A and 4A in the counterclockwise direction along the circumferential direction. The cutting widths J1, J2, K1 and K2 used in describing FIG. 15 are cutting widths of these measurement regions 4A, 2A, 3A and 1A, respectively. In FIGS. 17B to 17F, the other measurement regions are set on inclined axes G and H, which are inclined with respect to the X and Y axes at predetermined angles about the center P2 of the wafer W. In the drawings, reference numeral a designates an angle of the inclined axes G and H with respect to the X and Y axes. The measurement regions having the same inclination angle a belong to the same group. In FIGS. 17A to 17F, the measurement regions are represented for each group, and the measurement regions belonging to the same group are shown in gray scale.

In FIG. 17B, a group having an inclination angle α=15 degrees is defined as group B, and the respective measurement regions are designated by 1B, 2B, 3B and 4B, which are offset by 15 degrees from the measurement regions 1A, 2A, 3A and 4A, respectively. In like manner, a group having an inclination angle α=30 degrees is defined as group C, and the respective measurement regions are designated by 1C, 2C, 3C and 4C, respectively. A group having an inclination angle α=45 degrees is defined as group D, and the respective measurement regions are designated by 1D, 2D, 3D and 4D, respectively. A group having an inclination angle α=60 degrees is defined as group E, and the respective measurement regions are designated by 1E, 2E, 3E and 4E, respectively. A group having an inclination angle α=75 degrees is defined as group F, and the respective measurement regions are designated by 1F, 2F, 3F and 4F, respectively.

Therefore, with respect to the measurement region 1A in group A, the respective other measurement regions are set at positions offset every 15 degrees in the counterclockwise direction as viewed from the center of the wafer W. Hereinafter, for the convenience of description, in some cases, the cutting width of each measurement region is represented by adding a numerical value of an angle offset from the measurement region 1A after symbol L. For example, the cutting widths of the measurement regions 1A, 2A, 3A and 4A in group A are represented as L0, L90, L180 and L270, respectively. For example, according to this rule, the cutting widths of the measurement regions 1D, 2D, 3D and 4D in group D are represented as L45, L135, L225 and L315, respectively.

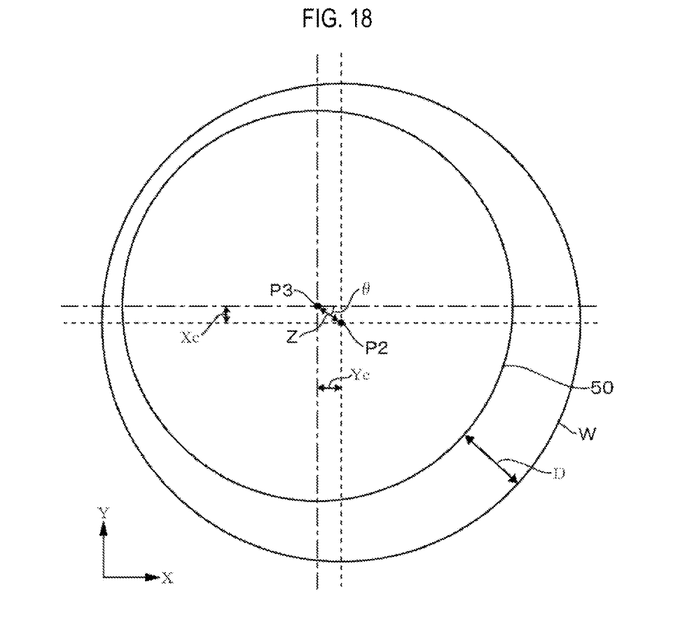

An eccentricity Xc (=ΔX) in the X direction of the center P3 of the resist film with respect to the center P2 of the wafer W, an eccentricity Yc in the Y direction of the center P3 with respect to the center P2, an eccentricity amount Z represented by a line segment connecting the center P2 and the center P3, an average cutting width E, and a maximum error D are calculated for the six groups A to F, respectively. These measurement items will be described with reference to FIG. 18. The average cutting width E is an average value of the cutting widths of the four measurement regions in the same group. The eccentricity Xc is equivalent to the correction amount ΔX of the transfer arm F in the X direction. The eccentricity Yc is equivalent to the correction amount ΔY of the transfer arm F in the Y direction. The maximum error D is an error obtained by taking into account both the average cutting width E and the eccentricity amount Z.

Since an allowable range is set for each item of the eccentricity Xc, the eccentricity Yc, the eccentricity amount Z, the average cutting width E, and the maximum error D, when each item departs from the allowable range, the control unit 6 recognizes the measured wafer W as a defective wafer W. Further explanation is given on the maximum error D. When the maximum error D is large, even if the average cutting width E and the eccentricity amount Z are within the allowable range, the region having the resist film removed may overlap the device forming region. Therefore, as described above, in addition to the calculation of the maximum error D, setting an allowable range for the maximum error D is performed.

In a process of obtaining the eccentricity Xc and the eccentricity Yc, an eccentricity t, an eccentricity u, and an eccentric angle θ are calculated. The eccentricity t is an eccentricity of the center P3 of the resist film with respect to the center P2 of the wafer W along the G axis which is an inclined axis of the X axis. The eccentricity u is an eccentricity of the center P3 of the resist film with respect to the center P2 of the wafer W along the H axis that is an inclined axis of the Y axis. The eccentric angle θ is an angle between the X axis and the line segment connecting the center P3 of the resist film 50 and the center P2 of the wafer W.

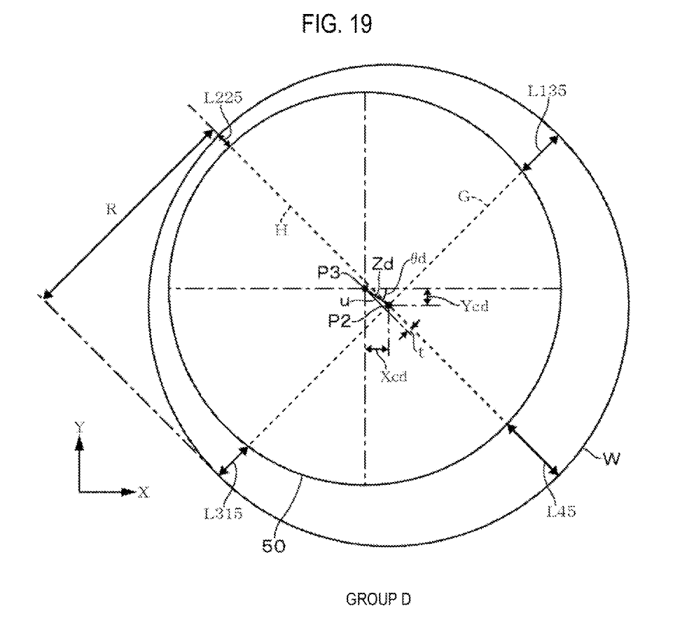

As an example, a method of calculating the average cutting width E, the eccentricities Xc and Yc, the eccentricity amount Z and the maximum error D of group D will be described with reference to FIG. 19. In order to distinguish the average cutting width E, the eccentricities Xc and Yc, the eccentricity amount Z, and the maximum error D of group D from those of the other groups, the average cutting width, the eccentricities, the eccentricity amount, and the maximum error calculated from group D are designated as Ed, Xcd and Ycd, Zd, and Dd, respectively. The average cutting width Ed is an average value of the four cutting widths, which is calculated by the following Equation 1.

Ed=(L45+L135+L225+L315)/4 (1)

In addition, assuming that a radius of the resist film having the unnecessary portion removed, which is a predetermined value, is r and similarly a radius of the wafer W, which is a predetermined value, is R, the following Equations 2 and 3 are obtained.

L135+r·cos θ−t=R (2)

L270+r·cos θ+t=R (3)

The following Equation 4 is obtained from Equations 2 and 3.

t=(L135−L315)/2 (4)

Also, in the same way as a case where the eccentricity t is calculated, the eccentricity u is calculated from the following Equation 5.

u=(L225−L45)/2 (5)

The eccentricity amount Zd and the eccentric angle θd are calculated from the following Equations 6 and 7.

Zd=(t2+u²)^{1/2} (6)

θd=tan⁻¹(t/u)−45° (7)

Based on the eccentricity amount Zd and the eccentric angle θd, the eccentricities Xcd and Ycd are calculated from the following Equations 8 and 9.

Xcd=Zd·cos θd (8)

Ycd=Zd·sin θd (9)

Also, using the calculated average cutting width Ed and eccentricity amount Zd and the cutting width target value, which is a predetermined value, the maximum error Dd is calculated from the following Equation 10.

Dd=|cutting width target value−average cutting width Ed|+eccentricity amount Zd (10)

For each of the groups other than group D, the average cutting width E, the eccentricity Xc, the eccentricity Yc, and the eccentricity amount Z are calculated from the cutting widths detected at the four measurement regions in the same way as group D. That is, using the cutting widths measured in each group instead of L45, L135, L225 and L315, the calculations by the respective Equations 1 to 10 are performed. Also, since the inclined axes G and H in group D are inclined at 45 degrees with respect to the X and Y axes, respectively, the eccentric angle is calculated by subtracting 45 degrees from the angle calculated from tan⁻¹(t/u) in Equation 7. Since the subtracted angle described above is an inclination of the inclined axes G and H of each group with respect to the X and Y axes, the value used for each group varies according to the inclination of the inclined axes. In group B, C, E and F, 15 degrees, 30 degrees, 60 degrees and 75 degrees are subtracted, respectively.

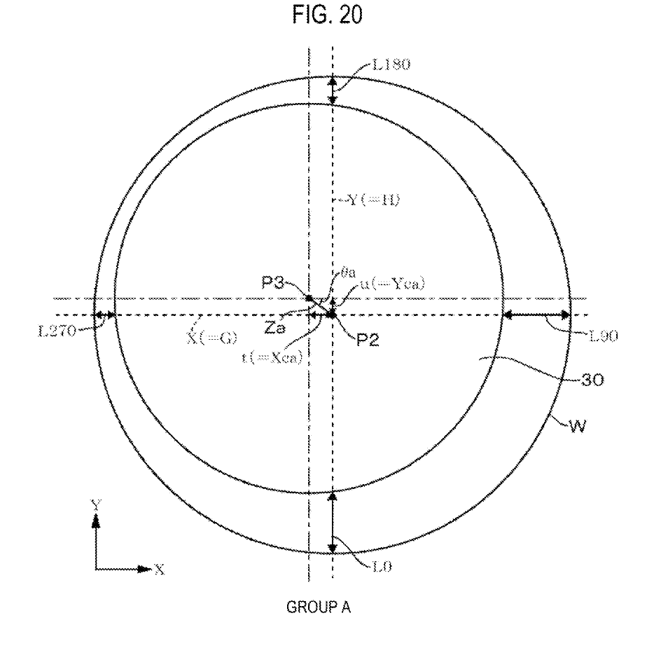

The calculations of the average cutting width E, the eccentricity Xc, the eccentricity Yc, the eccentricity amount Z, the eccentric angle θ and the maximum error D of group A will be described with reference to FIG. 20. In order to distinguish the calculated values of group A from those of the other groups, the average cutting width, the eccentricities, the eccentricity amount, the eccentric angle, and the maximum error are designated by Ea, Xca and Yca, Za, 0a, and Da, respectively. In Equation 1, since L0, L90, L180 and L270 are used instead of L45, L135, L225 and L315, (L0+L90+L180+L270)/4 is calculated. Also, for Equations 2 to 5, since L0, L90, L180 and L270 are used, the calculation is made with t=(L90−L270)/2 and u=(L180−L0)/2. The eccentricity amount Za is calculated from eccentricities t and u in the same manner as Zd of group D. In addition, in group A, the inclined axes G and H coincide with the X and Y axes, respectively. That is, since an angle between the X or Y axis and the inclined axis G or H is 0 degree, Equation 7 is calculated as the eccentric angle θa=tan⁻¹(t/u)−0 degree. In addition, Xca=Za·cos θa and Yca=Za·sin θa are calculated by Equations 8 and 9. Also, the maximum error Da is calculated by Equation 10 in the same way as in group D. Further, in group A, since the X and Y axes coincide with the inclined axes G and H as described above, the eccentricities t and u calculated from Equations 4 and 5 are eccentricities Xca and Yca, respectively.

In groups A to F, assuming that the average cutting widths are Ea to Ef, respectively, the eccentricities Xc are Xca to Xcf, respectively, the eccentricities Yc are Yca to Ycf, respectively, the eccentricity amounts Z are Za to Zf, respectively, the eccentric angles θ are θa to θf, respectively, and the maximum errors D are Da to Df, respectively, average values for these respective items are calculated. That is, an average cutting width is calculated from (Ea+Eb+Ec+Ed+Ee+Ef)/6, the calculated value becomes a final measured average cutting width. In the same manner, respective average values of the eccentricities Xc, the eccentricities Yc, the eccentricity amounts Z, the eccentric angles θ and the maximum errors D detected from the respective groups are calculated, and the calculated average values become the final measured eccentricity Xc, the final measured eccentricity Yc, the final measured eccentricity amount Z, the final measured eccentric angle θ and the final measured maximum error D. Based on the eccentricity Xc and the eccentricity Yc, the correction amounts of the delivery position in the X direction and the Y direction are calculated, respectively. Based on the average cutting width, the correction amount of the solvent processing position of the peripheral portion solvent supply nozzle 57 is calculated.

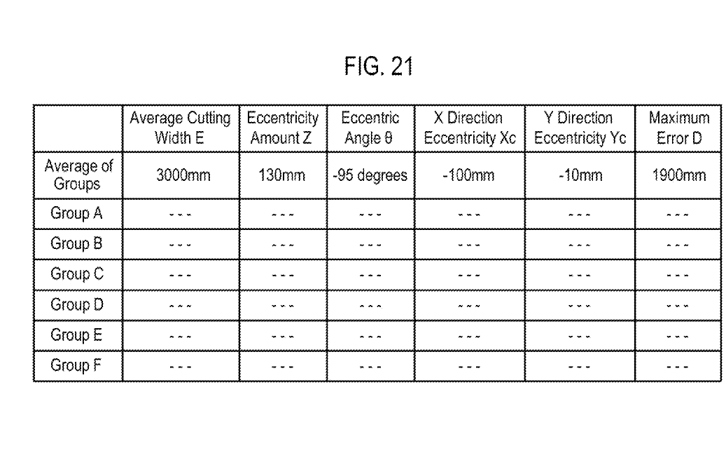

The table of FIG. 21 shows respective measurement items obtained from the image data of one sheet of wafer W. As described above, the average cutting width, the eccentricity Xc, the eccentricity Yc, the eccentricity amount Z, the eccentric angle θ and the maximum error D are calculated for each group, and average values of the same measurement items for each groups is calculated. These calculated measurement values are stored in the control unit 6 for each wafer W. As shown in the table, in this example, each of the average cutting width, the eccentricity Xc, the eccentricity Yc, the eccentricity amount Z and the maximum error D has a unit of mm, and the eccentric angle θ has a unit of degree.

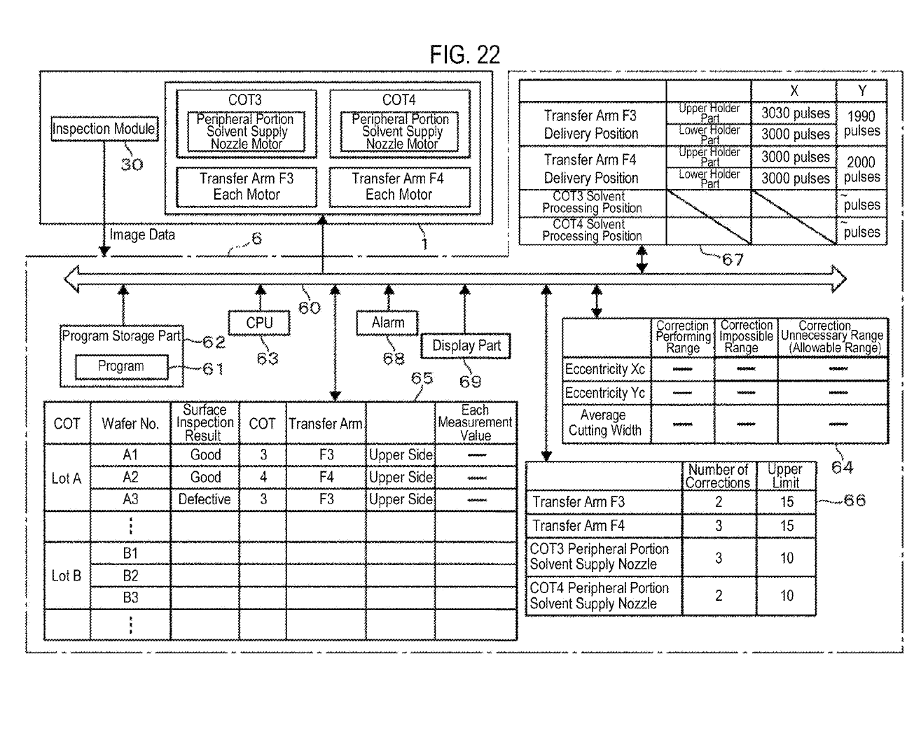

Subsequently, the control unit 6 will be described with reference to FIG. 22. A transfer body operation part, a moving mechanism operation part and a data processing part of the claims are included in the control unit. The control unit 6 is provided with a program storage part 62 having the program 61 and a CPU 63 executing various operations. In the figure, reference numeral 60 designates a bus to which the program storage part 62 and the CPU 63 are connected. The program 61 consists of a group of steps of controlling the transfer of wafers W and processing the wafers W in the respective modules by transmitting control signals from the control unit 6 to the respective parts of the coating and developing apparatus 1. For example, the control signals are sent to the above-described respective motors, whereby the holding and supporting body 2 of the transfer arm F may move between the modules and move to the delivery position of the wafers W for the respective modules including the resist film forming modules COT. In the same way, the peripheral portion solvent supply nozzle 57 in the resist film forming module COT may also move between the standby position and the solvent processing position based on the control signal. In addition, the quality determination of the surface state of the resist film is also performed by the program 61. The program storage part 62 may be implemented with, for example, a storage medium, such as, a flexible disk, a compact disk, a hard disk, an MO (magneto optical disk) memory card and so on, and the program 61 is installed in the control unit 6 from a stored state in the storage medium.

The control unit 6 has a first storage part 64. The first storage part 64 stores correction performing ranges, correction impossible ranges and correction unnecessary ranges (allowable ranges) for the eccentricity Xc, the eccentricity Yc and the cutting width E calculated from the respective groups as described above. They are used to determine whether or not the corrections for the delivery position of the transfer arm F and the solvent processing position of the peripheral portion solvent supply nozzle 57 of the resist film forming module COT should be performed and whether or not the transfer arm F and the module COT are set to be unusable. Also, although not shown, the correction impossible ranges and the allowable ranges of the maximum error D and the eccentricity amount Z are also stored in the first storage part 64.

The control unit 6 has a second storage part 65. The second storage part 65 stores IDs of lots and wafers W provided by the control unit 6. In addition, the second storage part 65 stores data for each wafer W, such as which of the resist film forming modules COT processes the wafer W, which of the transfer arms F transfers the wafer W to the resist film forming module COT, which of the upper and the lower holding and supporting bodies 2 transfers the wafer W to the resist film forming module COT, in association with one another. In addition, the second storage part 65 stores values of the respective measurement items, i.e., the average cutting width E, the eccentricity Xc, the eccentricity Yc, the eccentricity amount Z, the eccentric angle θ and the maximum error D described in FIG. 21 for each wafer W. The above-described quality determination of a surface state of the resist film is also stored for each wafer W.

In addition, the control unit 6 is provided with a third storage part 66. The third storage part 66 stores, for example, the number of corrections of the delivery positions of the transfer arms F3 and F4 and the number of corrections of the solvent processing position of the peripheral portion solvent supply nozzle 57 of each resist film forming module COT after the coating and developing apparatus 1 is energized. Although it is possible to repeatedly perform the correction, an upper limit of the number of times the correction is performed is set, and the upper limit is also stored in the third storage part 66.

In addition, the control unit 6 is provided with a fourth storage part 67. The fourth storage part 67 stores data of the delivery positions of the transfer arms F3 and F4 toward the resist film forming modules COT. The data are position data in the X and Y directions as described above, and the position data in the X direction is stored for each of the holding and supporting bodies 2 of the transfer arms F. These data are stored as pulse values of the encoders as described above and corrected based on the eccentricity Xc and the eccentricity Yc. In addition, data on the solvent processing position of the peripheral portion solvent supply nozzle 57 of each resist film forming module COT is also stored as a pulse value of the encoder. This data is corrected by the above-described average cutting width E. Further, for the convenience of depiction and description, although four divided storage parts are provided, they may be configured by a common memory.

In addition, the control unit 6 has an alarm output part 68. The alarm output part 68 outputs an alarm when there is a measurement item included within the correction impossible range, or when the cutting width E, the eccentricity Xc or the eccentricity Yc is not included within the allowable range even though the correction of the delivery position of the transfer arm F or the solvent processing position is performed up to the upper limits as described later. As the alarm output, a predetermined indication is displayed on a screen, or a predetermined sound is output.

The control unit 6 is provided with a display part 69 including a display device. The data stored in the second storage part 65 are displayed on the display part 69. Specifically, for each wafer W, whether a surface inspection result is good or defective, the resist film forming module COT in which the wafer W was processed, the transfer arm and the holding and supporting body which transfers the wafer W to the module COT, and the values of the respective measurement items obtained from the image data are displayed in association with one another.

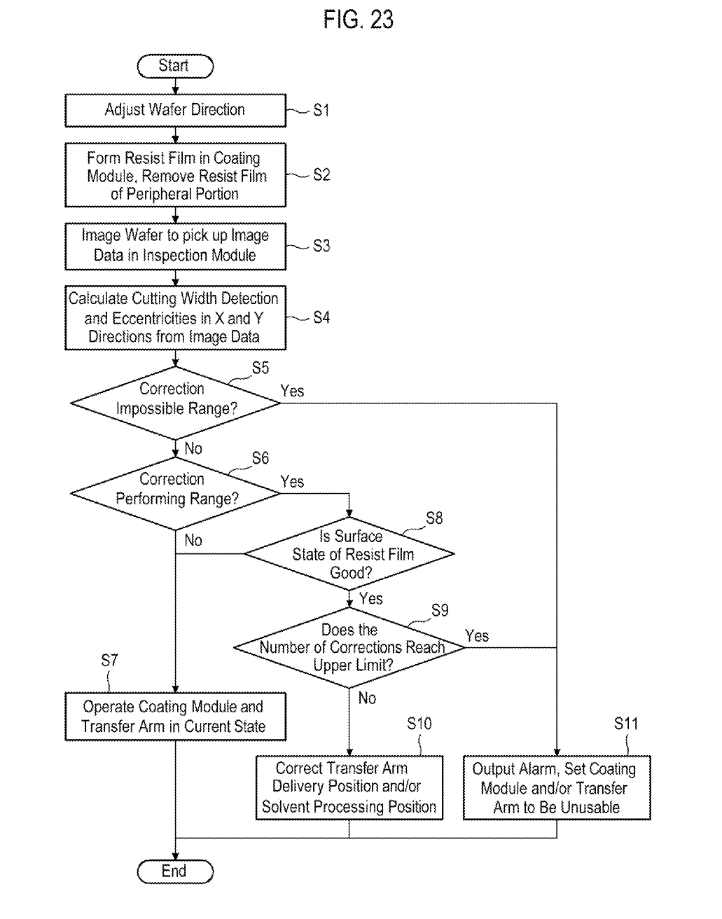

Subsequently, a process of correcting the delivery position of the transfer arm F3 or F4 and the solvent processing position will be described with reference to the flow chart of FIG. 23. In describing the flow, it is assumed that the wafer W first loaded into the coating and developing apparatus 1 is referred to as W1 and the subsequent wafer W is designated with W2. It is also assumed that the wafers W1 and W2 are set to be transferred through the same transfer path and transferred to the resist film forming module COT using the same holding and supporting body 2.

As described above, the wafer W1 transferred to the coating and developing apparatus 1 and having an anti-reflective film formed thereon is loaded into the direction adjusting module 32 of the unit block E3 (E4), and then, the direction of the wafer W1 is adjusted so that the notch N faces a predetermined direction (Step S1). The holding and supporting body 2 of the transfer arm F3 (F4) holding and supporting the wafer W1 moves to the delivery position on the spin chuck 51 of the resist film forming module COT3 (COT4) based on the data of the delivery position stored in the control unit 6, and thus, the wafer W1 is delivered to the spin chuck 51 as described in FIG. 8. Which one of the resist film forming modules COT3 and COT4 is the resist film forming module to which the wafer W1 is delivered, which of the transfer arms F3 and F4 is the transfer arm transferring the wafer W1, and which of the upper and lower holding and supporting bodies 2 transfers the wafer W1 to the resist film forming module COT3 are stored in the control unit 6.

As illustrated using FIG. 9, a resist film is formed on the entire surface of the wafer W. Subsequently, based on the data of the solvent processing position stored in the control unit 6, the peripheral portion solvent supply nozzle 57 moves to the solvent processing position, the solvent is ejected to the peripheral portion of the wafer W1, and the unnecessary portion of the resist film is removed as described using FIGS. 10 to 12 (Step S2).

After the processing in the heating module 31 is completed, the wafer W1 is transferred to the inspection module 30, its image is imaged by the camera, and the image data obtained thereby is transmitted to the control unit 6 (Step S3). The determination of whether a surface state of the resist film is good or defective is performed on the image data, and the determination result is stored in the control unit 6. In addition, the average cutting width E, the eccentricity Xc, the eccentricity Yc, the eccentricity amount Z, the eccentric angle θ, and the maximum error D are calculated for each of the above-described groups A to F from the above-described image data. Then, the average values of the six groups A to F for the cutting width E, the eccentricity Xc, the eccentricity Yc, the eccentricity amount Z, the eccentric angle θ, and the maximum error D are calculated, these calculated values are stored in the control unit 6 (Step S4). In the description on this flow, if the average cutting width E, the eccentricity Xc, the eccentricity Yc, the eccentricity amount Z, the eccentric angle θ, and the maximum error D are simply mentioned hereinafter, they indicate average values of groups A to F.

It is determined whether or not the value of each inspection item of the calculated average cutting width E, the calculated eccentricity Xc, the calculated eccentricity Yc, the calculated eccentricity amount Z and the calculated maximum error D is within the predetermined correction impossible range (Step S5). If it is determined in Step S5 that any inspection item is not included within the correction impossible range, it is determined whether the parameters of the eccentricity Xc, the eccentricity Yc and the average cutting width E are included within the correction performing ranges (Step S6). If it is determined in Step S6 that any parameter is not included within the correction performing range, since each inspection item falls within the correction unnecessary range, without correcting the delivery position of the transfer arm F and the solvent processing position of the peripheral portion solvent supply nozzle 57, the succeeding wafer W2 is delivered to the resist film forming module COT in the same way as the wafer W1, and then, the unnecessary portion of the resist film is removed (Step S7).

If it is determined in Step S6 that any one of the eccentricity Xc, the eccentricity Yc and the average cutting width E is included within the correction performing range, based on the data stored in the control unit 6, it is determined whether a surface state of the resist film of the wafer W1 is good or defective (Step S8). If it is determined in Step S8 that the surface state of the resist film is defective, the above-described Step S7 is performed to deliver the succeeding wafer W2 to the resist film forming module COT and remove the unnecessary portion of the resist film without correcting the delivery position and the solvent processing position. The reason why the correction is not based on a wafer W, which has been determined to have a defective surface state, is that a resist film may not normally be formed on a wafer W with a defective surface state.

When it is determined in Step S8 that the surface state of the resist film is good, if any one of the eccentricity Xc and the eccentricity Yc is included within the correction performing range, it is determined whether or not the number of corrections of the delivery position of the transfer arm F transferring the wafer W1 reaches the upper limit. In addition, if the cutting width E is included within the correction performing range, it is determined whether or not the number of corrections of the solvent processing position of the resist film forming module COT which has processed the wafer W1 reaches the upper limit (Step S9).

In Step S9, when it is determined that the number of corrections for the delivery position does not reach the upper limit, the correction of the delivery position is performed. For the parameter included within the correction performing range among the eccentricity Xc and the eccentricity Yc, the correction amount ΔX or ΔY, which is a pulse value of the encoder converted from the eccentricity value, is calculated. The equations for conversion from the eccentricities Xc and Yc to the correction amounts ΔX and ΔY are stored in the control unit 6 in advance. In addition, as illustrated using FIG. 15, the data of the delivery position stored in the fourth storage part 67 are corrected by the correction amounts ΔX and ΔY calculated in this way. That is, the data of the delivery position in the Y direction of the transfer arm F among the transfer arms F3 and F4, which has delivered the wafer W1 to the resist film forming module COT, is corrected by the correction amount ΔY. The data of the delivery position in the X direction of the holding and supporting body 2 among two holding and supporting bodies 2 of the transfer arm F, which has held and supported the wafer W1, is corrected by the correction amount ΔX. Such corrections are performed, and the number of corrections of the transfer arm F is updated to increase by one.

Also, when it is determined in Step S9 that the number of corrections of the solvent processing position does not reach the upper limit, a difference (μm) between the measured average cutting width E and the cutting width target value is calculated, and the correction amount ΔE, which is a pulse value of the encoder converted from the difference value, is calculated. The conversion equation and the target value are stored in the control unit 6 in advance. In addition, the data of the solvent ejection position of the resist film forming module COT, which has processed the wafer W1, is corrected by the correction amount ΔE calculated in this way. This correction is performed in the same way as the correction of the delivery position of the transfer arm F, and, for example, if the pulse value of the data of the solvent ejection position is stored as A, A−ΔE is stored as the data of the solvent ejection position after the correction. In addition to performing the correction, the number of corrections of the solvent processing position of the module COT is updated to increase by one (Step S10).

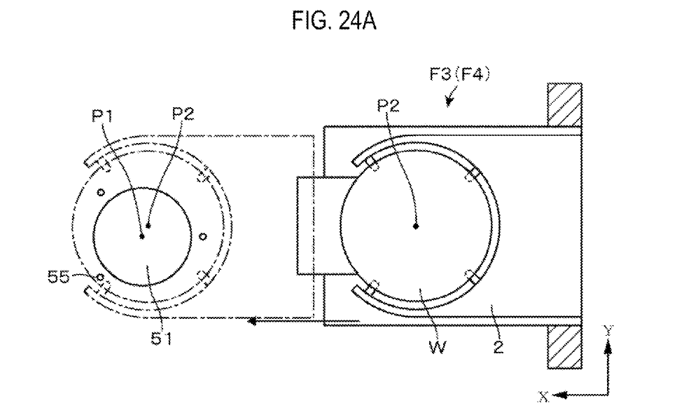

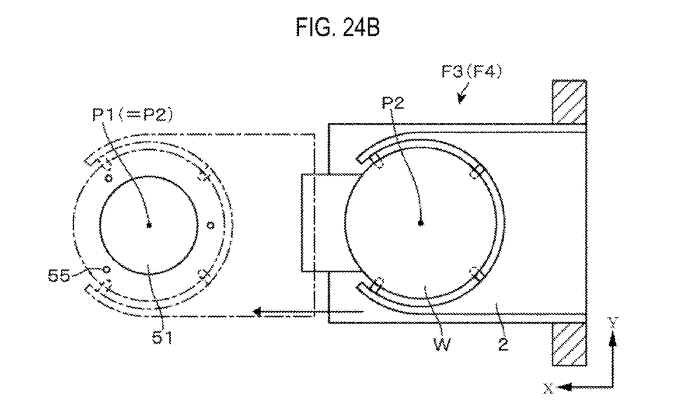

FIGS. 24A and 24B show that the delivery position is corrected. As shown in FIG. 24A, the wafer W1 is transferred to the delivery position (shown in a dot-dashed line in the figure) of the wafer W by the holding and supporting body 2 of the transfer arm F3 (F4) so that the center P2 of the wafer W1 is eccentric with respect to the rotational center P1 of the spin chuck 51. Then, the flow is performed as described above, whereby the data of the delivery position is corrected. Here, description is made with the assumption that both the eccentricities Xc and Yc are included within the correction performing range, and the data of the delivery position are corrected in both the X direction and the Y direction.

Thereafter, the holding and supporting body 2 of the transfer arm F3 (F4) holding and supporting the succeeding wafer W2 moves to the delivery position according to the stored data. Since the data have been corrected, the center P2 of the wafer W2 and the rotational center P1 of the spin chuck 51 coincide with each other as shown in FIG. 24B. After this delivery, the same process as the wafer W1 is performed in the resist film forming module COT, so that the center P3 of the resist film formed as shown in FIG. 13 coincides with the center P2 of the wafer W.

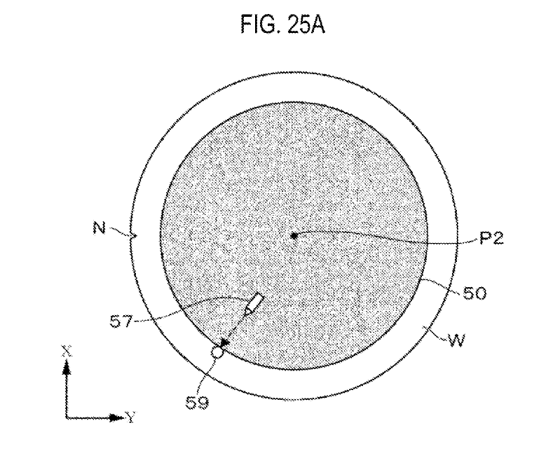

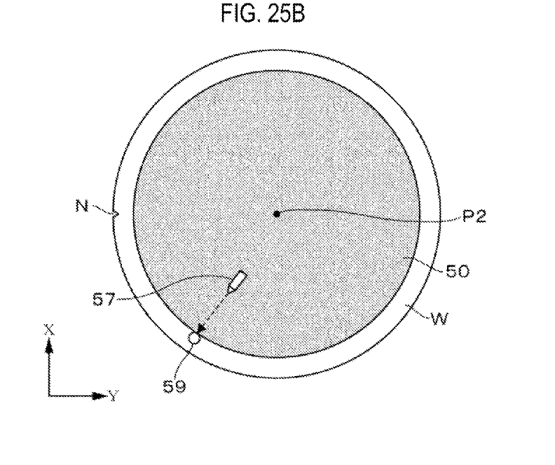

FIGS. 25A and 25B show that the solvent processing position is corrected. Description is made in this example, assuming that, as shown in FIG. 25A, when the wafer W1 is processed, the solvent ejection position 59 of the peripheral portion solvent supply nozzle 57 is positioned at a relatively inward side of the wafer W1, and as a result of the inspection of the wafer W1, the cutting width E is smaller than the predetermined target value.). Then, if, as the flow progresses as described above, the data of the solvent processing position is corrected, the wafer W2 is loaded, and the resist film is formed, the peripheral portion solvent supply nozzle 57 moves according to the data of the corrected solvent processing position. FIG. 25B shows the wafer W2, which is processed by the peripheral portion solvent supply nozzle 57. The peripheral portion solvent supply nozzle 57 is positioned at a more outward side of the wafer W as compared with when the wafer W1 is processed, and the solvent ejection position 59 is also positioned to reach the outward side of the wafer W. Accordingly, the cutting width of the resist film 50 becomes a new target value.

After the processing in the resist film forming module COT is terminated as described above, wafer W2 is transferred to the respective modules such as the inspection module 30 in the same way as wafer W1. In the examples of FIGS. 24A and 24B and 25A and 25B, as a result of the corrections of the delivery position and the solvent processing position, when the wafer W2 is processed, no correction is performed under the assumption that each measurement item is included within the correction unnecessary range. However, since the wafer W2 is also processed according to the flow of the wafer W1, depending upon the result of analyzing the image data of the wafer W2, Steps S6, S8, S9 and S10 may be performed, thereby correcting the data again. That is, as long as the number of corrections is not exceed, the upper limit set in the third storage part 66, the delivery position and the solvent processing position are repeatedly corrected until each parameter is included within the correction unnecessary range.

Returning to the description of the flow chart of FIG. 23, when it is determined in Step S9 that the number of corrections of the delivery position of the transfer arm F reaches the upper limit, the transfer arm F is set to be unusable. A case where the transfer arm F3 is set to be unusable will be described as an example. If the above determination is made, the transfer to the transfer module TRS3 serving as the loading port for the unit block E3 is stopped. In addition, if the transfer arm F3 transfers wafers W, which have already been loaded in the unit block E3, in the above-described path and these wafers W are unloaded from the unit block E3, the operation of the transfer arm F3 is stopped. As described above, the operation of the transfer arm F3 is not immediately stopped, which is for the purpose of preventing the wafers W, which are not normally processed by such stop, from increasing in number. In addition, for the wafers W set to be transferred to the unit block E3, their transfer path is changed so that they are processed in the unit block E4. In case the transfer arm F4 is set to be unusable, in the same way, the transfer of wafers W to the transfer module TRS4 is stopped, the wafers W are unloaded from the unit block E4, and the transfer path of succeeding wafers W is changed to the unit block E3.

In addition, if it is determined that the number of corrections of the solvent processing position of the peripheral portion solvent supply nozzle 57 in the resist film forming module COT3 (COT4) exceeds a predetermined number of times, the resist film forming module COT3 (COT4) is set to be unusable, and the transfer of wafers W to the module COT in question is stopped. In this embodiment, since one unit block has only one resist film forming module COT, the transfer of wafers W to the unit block including the resist film forming module COT in question is stopped in the same way as a case where the transfer arm F is set to be unusable.

In addition, if such a transfer arm or resist film forming module COT is set to be unusable, an alarm is output in order to show which of the transfer arms F3 and F4 and the resist film forming modules COT3 and COT4 is set to be unusable and alerts the user of the coating and developing apparatus 1 to repair the transfer arm or module (Step S11).

Even when it is determined that at least one of the setting items calculated in Step S5 is included within the correction impossible range, Step S11 is performed. That is, the transfer arm F and the resist film forming module COT which transferred the wafer W1 out are set to be unusable, and an alarm is output in order to urge their repair.

However, when a plurality of the resist film forming modules COT are used in one unit block E and one of the resist film forming modules COT is set to be unusable, if the other resist film forming module(s) COT is usable, the succeeding wafers W which were set to be transferred to the unusable resist film forming module COT are set to be transferred to the usable resist film forming module COT. That is, the transfer of wafers W to the unit block E is not stopped, and the processing of the wafers W in the unit block E is continuously performed.

According to the above-described coating and developing apparatus 1, the cutting widths are detected at the plurality of regions of the wafer W in its circumferential direction based on the image data acquired by the inspection module 30 for inspecting the surface state of the resist film, and measurement items for correcting the delivery position of the transfer arm F to the resist film forming module COT and the solvent processing position of the peripheral portion solvent supply nozzle 57 of the resist film forming module COT are calculated based on the cutting widths. In addition, the delivery position and the solvent processing position are corrected by the calculated data. Therefore, it is unnecessary to unload the wafer W processed in the resist film forming module COT outside of the apparatus 1. Also, it is unnecessary for the user of the apparatus 1 to memorize the wafer W, the resist film forming module COT in which the wafer W in question was processed, the transfer arm F that transferred that wafer W to the resist film forming module COT, and the measurement results of the cutting widths of the wafer W in association with one another, or to make a note for the information on the association. Therefore, it is possible to reduce user's efforts and to prevent man-made errors, for example, the improper correction due to the difference in the user's memory or confusion.

Also, in the first embodiment, if the cutting widths are detected from the image data, the control unit 6 automatically performs the correction of the delivery position and the solvent processing position based on the cutting widths. Therefore, the correction is rapidly performed while the number of wafers W for which the inspection results for the respective calculated parameters are improper are prevented from being increased, whereby it is possible to further lessen the user's efforts.

In addition, the inspection module 30 of picking up the image data is the module for also detecting the surface state of the resist film, and both the calculation of the respective parameters and the determination of whether the surface state of the resist film is good or defective from the obtained image data are performed in parallel. Therefore, since it is unnecessary to install a dedicated module for obtaining the correction data, the number of modules installed in the coating and developing apparatus 1 can be reduced, thereby preventing the apparatus from being enlarged. Furthermore, since the calculation of the correction data as described above is not performed on the wafer W determined to have a defective surface state, improper correction data can be prevented from being produced, which therefore makes it possible to reduce the number of improperly processed wafers.

The acquisition of the image data by means of the inspection module 30 is not limited only to performing the acquisition on all the wafers W, and for example, the acquisition may be performed only on a leading wafer W of a lot. Also, in the first embodiment, the corrections of the delivery position and the solvent processing position are not limited to being performed immediately after the correction values are calculated. For example, even if the calculation of the correction values for lot A first loaded into the apparatus 1 are completed by the inspection, the correction is not performed during the processing of lot A. Then, after the processing of lot A is completed, the correction is performed before lot B is subsequently loaded in the apparatus 1 and transferred to the resist film forming module COT. In this manner, it may be possible to have the respective wafers W in the same lot to be in the same processed states.

### Second Embodiment

The control unit 6 is not limited to automatically performing the corrections of the delivery position and the solvent processing position. In the second embodiment, the respective measurement items are calculated based on the image data in the same way as the first embodiment. The respective measurement items are displayed on the display part 69. The display part 69 includes a touch panel or the like, through which the user determine whether or not the correction is performed according to the calculated measurement items. In addition, the user may also perform the correction by changing the respective calculated measurement items through the display part 69. The display part 69 in this embodiment constitutes the transfer body operation part and the moving mechanism operation part of the claims.

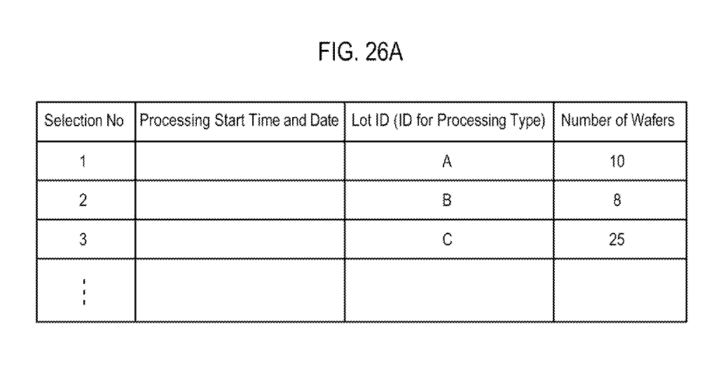

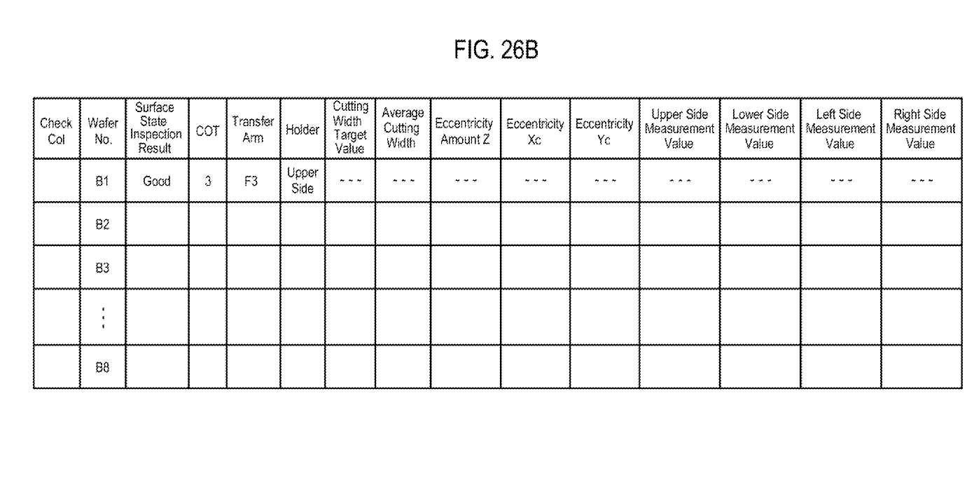

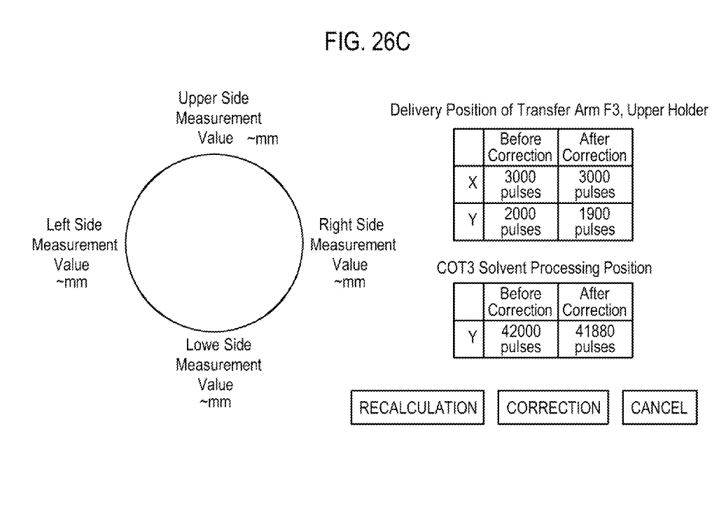

FIGS. 26A to 26C show an example of the screen display of the display part 69. The screen display is changed from FIG. 26A to FIG. 26B and from FIG. 26B to FIG. 26C by the user's instructions. The table of FIG. 26A will now be described. The table shows an ID of each lot, a time to initiate the processing of each lot and the number of wafers W included in each lot in association with each other. The user selects one of the selection numbers assigned to the lots to select a lot for which the respective measurement items will be displayed. Meanwhile, since the same kind of processing is performed on the same lot, the screen may also be referred to as a screen for displaying the data of the wafers W having been subjected to the predetermined processing.

The table of FIG. 26B will now be described. The data of the wafers W included in the lot selected in the table of FIG. 26A are displayed on the screen for each relevant wafer W. This screen display is completed based on the data stored in the second storage part 65. The displayed data are data for an ID of each wafer W, whether the surface state of the resist film is good or defective, which of the resist film forming modules COT processes the wafer W, which of the transfer arms transfers the wafer W to the module COT, and which of the upper and lower holding and supporting bodies 2 transfers the wafer W. In addition, the cutting width target value, and the average cutting width E, the eccentricity amount Z, the eccentricity Xc, and the eccentricity Yc, which are calculated from the respective groups A to F, are also displayed. Each of the average cutting width E, the eccentricity amount Z, the eccentricity Xc, and the eccentricity Yc is the average value of the above-described groups A to F.

Further, an upper side measurement value, a lower side measurement value, a left side measurement value and a right side measurement value in the table will be described. It is assumed that an average of cutting widths of one side's end (the right side in FIGS. 17A to 17F) of the inclined axes G of the respective groups A to F is the right side measurement value, and an average of cutting widths of the other side's end (the left side in FIGS. 17A to 17F) of the inclined axes G is the left side measurement value. It is assumed that an average of cutting widths of one side's end (the upper side in FIGS. 17A and 17F) of the inclined axes H of the respective groups A to F is the upper side measurement value, and an average of cutting widths of the other side's end (the lower side in FIGS. 17A to 17F) of the inclined axes H is the lower side measurement value. In addition, it is assumed that for group A, the X axis is the inclined axis G and the Y axis is the inclined axis H. From a check column provided for the respective wafers W, the user may designate wafers W whose data are used to perform the respective corrections.

The screen of FIG. 26C will now be described. In this screen, respective average values of the upper side measurement values, the lower side measurement values, the right side measurement values and the left side measurement values of the wafers W designated in the screen of FIG. 26B are displayed. When only one wafer W is designated, the respective measurement values of the selected wafer W are displayed instead of the aforementioned average values.

Also, the data of the delivery position currently set in the transfer arm F and the holding and supporting body 2 thereof transferring the designated wafer W and the data of the solvent processing position currently set for the peripheral portion solvent supply nozzle 57 of the resist film forming module COT processing the designated wafer W are displayed in this screen. The display of them is based on the data of the fourth storage part 67.

In addition, the delivery position in the X direction after the correction and the delivery position in the Y direction after the correction are also displayed. The delivery position in the X direction after the correction is calculated by an average value of the eccentricities Xc of the designated wafers W and the delivery position currently set in the X direction. In the same way, the delivery position in the Y direction after the correction is calculated by an average value of the eccentricities Yc of the selected wafers W and the delivery position currently set in the Y direction.

Further, the solvent processing position after the correction is also displayed. The solvent processing position after the correction is calculated by an average value of the average cutting widths of the designated wafers W and the solvent processing position currently set.

In the screen of FIG. 26C, a correction button, a cancel button, and a recalculation button are displayed. If the correction button is touched, the delivery position and the solvent processing position change into the values being set in this screen. That is, the data of the fourth storage part 67 are updated, and then, the transfer arm F and the peripheral portion solvent supply nozzle 57 move based on the corrected data in the same way as the first embodiment. If the cancel button is pressed, the correction is not performed and this screen is closed.

The user may changes the upper side measurement value, the lower side measurement value, the right side measurement value, and the left side measurement value displayed on the screen of FIG. 26C. After the change, by pressing the recalculation button, the recalculation for the delivery position and the solvent processing position after the correction is performed based on these changed values, and then, the calculated values are displayed on the screen. In addition, values of the delivery position and the solvent processing position after the correction may also be changed by the user's input. After the change, by pressing the correction button, the data of the fourth storage part 67 are updated to the delivery position and the solvent processing position which are changed in this screen. Although not shown in the screen of FIG. 26C, the cutting width target value may be changed through the screen and the recalculation may be performed according to the changed value.

Although the first and second embodiments have been described distinctively, these embodiments may be combined to constitute a single apparatus. Further, for example, a configuration where the user can select one of both the correction according to the first embodiment and the correction according to the second embodiment may be possible.

In addition, although, in order to allow the direction of the wafer W to be secured at the time of when the wafer is delivered to the spin chuck 51 and when the wafer is loaded into the inspection module 30, the direction of the wafer W is adjusted using the direction adjusting module 32 before the delivery, the present disclosure is not limited to such direction adjustment of the wafer W. The detection of the notch N may be performed by the image data of the inspection module 30. In addition, since the wafer W does not rotate in the heating modules 31 and the holding and supporting body 2 of the transfer arm F on the way from the resist film forming module COT to the inspection module 30 and the rotation amount of the wafer W in the resist film forming module COT can be detected by the control unit 6 as described above, the position of the notch N of the wafer W when the wafer W is delivered to the spin chuck 51 can be seen from the position of the notch N. That is, since the X and Y axes of the wafer W can be detected, the above-described X and Y directions can be corrected.

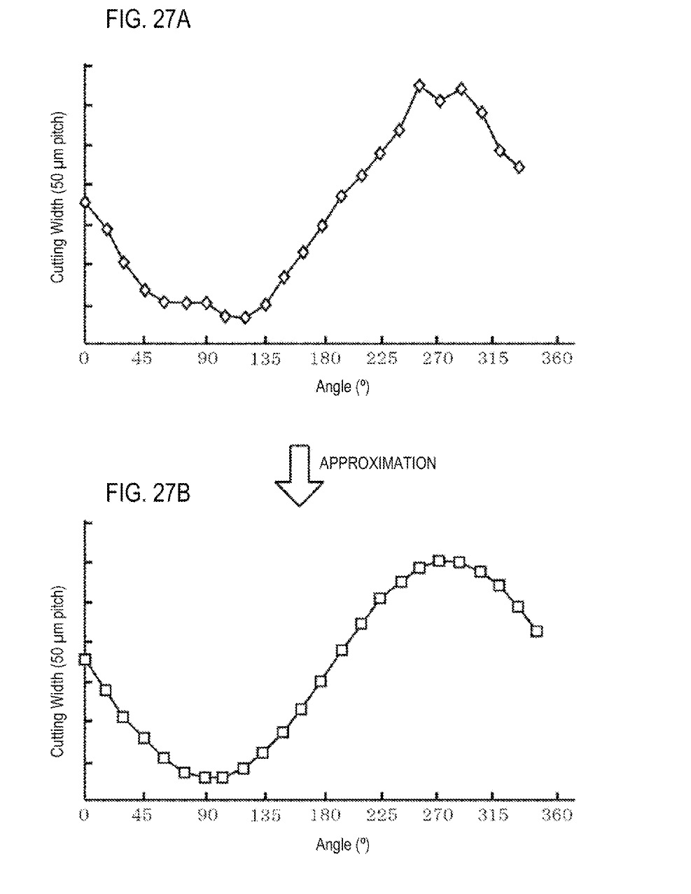

In addition, the method of calculating the respective parameters based on the cutting widths is an example, and the method is not limited to this example. Description of another example is made assuming that the cutting widths are detected from the image data as shown in a graph of FIG. 27A. The horizontal axis of the graph represents the respective measurement regions of groups A to F. Specifically, the measurement region 1A is represented by 0 degree, and the other measurement regions are represented by angles offset from the measurement region 1A around the center P2 of the wafer W. The vertical axis represents the cutting width (unit: μam) by a pitch of 50 μm.

A curve of the graph consisting of the cutting width data is approximated to draw a sine curve as shown in the graph of FIG. 27B, for example, using a least squares method. That is, the correction is performed such that the data of the respective cutting widths are on this sine curve. Using the corrected cutting widths, the above-described respective parameters may be calculated. In addition, when the approximation to the sine curve is performed as described above, the amplitude of the sine curve corresponds to the eccentricity amount Z. Also, for the obtained sine curve, a phase offset with respect to a predetermined sine curve corresponds to the eccentric angle θ. The eccentricity Xc and the eccentricity Yc may be calculated from the eccentricity amount Z and the eccentric angle θ.

Although both the correction of the delivery position and the correction of the solvent processing position are performed in this example, only one of them may be performed. Although measurement precision may be increased through the measurements at the plurality of positions as described above, four measurement regions may be sufficient to correct the delivery position. In addition, in order to correct only the solvent processing position, one measurement region is sufficient. Further, the resist coating is performed by another module, and the resist film forming module COT may be configured as a module of only removing the unnecessary portion of the resist film. Furthermore, although not described in the respective embodiments, the peripheral portion solvent supply nozzle 57 moves toward the outside of the rotating wafer W after the ejection of solvent is initiated and thus the removal of the resist film is performed by moving the ejection position of the solvent on the wafer W toward the outside, thereby performing the removal of the resist film. However, without moving the nozzle, spreading the solvent on the wafer W toward its circumferential end only by the centrifugal force caused by the rotation of the wafer W may be possible. In addition, when correction is made to an inner side position of the solvent ejection position on the wafer W, moving the nozzle 57 from the outside to the inside may be possible.

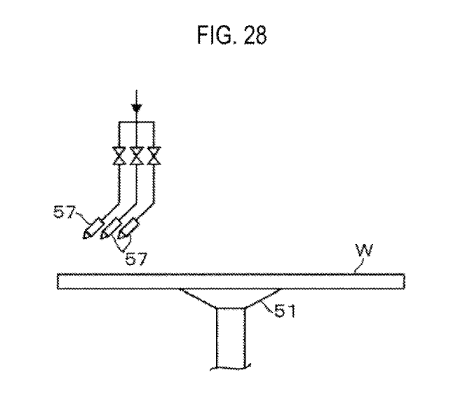

In addition, the peripheral portion solvent supply nozzle 57 will work as long as its solvent ejection position can be changed between the inward side and the outward side of the wafer W. Therefore, for example, as shown in FIG. 28, a plurality of peripheral portion solvent supply nozzles 57 for ejecting the solvent to different ejection positions from each other may be installed, and when the correction of the solvent processing position is performed, the correction may be performed by controlling opening/closing of valves V of the respective nozzles 57. Otherwise, the inclination of the nozzle 57 may be changed. Although the resist film has been described as an example of the coating film in the respective embodiments, the present disclosure is not limited to the removal of the resist film but, for example, may be applied to removal of the anti-reflective film. In addition, the image data acquisition by the inspection module 30 needs only to be performed on the wafer W having the coating film of the peripheral portion thereof removed. Therefore, the wafer W subjected to the development processing and having a pattern formed on the resist film is transferred to the inspection module 30, and then, the image data of the wafer W may be acquired. Therefore, the cutting width may be detected from the image data for use in determining whether or not a size of a pattern is proper by using a surface state.

According to the present disclosure, an image data of a substrate having an unnecessary portion of a coating film removed is acquired, removal widths of the coating film are detected from the image data, and the delivery position for delivering the succeeding substrate from a substrate transfer body to a substrate rear surface supporting part is made to be offset based on the respective removal widths in order to prevent eccentricity of the coating film of the succeeding substrate having the unnecessary portion removed.

Further, in another configuration, the removal widths of the coating film are detected from the image data, and for the succeeding substrate, a solvent supply position is offset such that the removal widths become setting values. By adjusting the apparatus based on the image data as described above, it is possible to remove the need for transferring the substrate to the outside of the apparatus in order to inspect the substrate in an inspection device outside the apparatus, so that it is easy to adjust the apparatus. Also, in these configurations, since the image data is acquired in the inspection module for inspecting the coating film state, the apparatus need not be provided with a dedicated module for acquiring image data, so that it is possible to prevent the apparatus from being enlarged and complicated in configuration.

While certain embodiments have been described, these embodiments have been presented by way of example only, and are not intended to limit the scope of the disclosures. Indeed, the novel methods and apparatuses described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A method of removing a coating film of a substrate peripheral portion, comprising:
holding and supporting a circular substrate by allowing a transfer body to transfer a rear surface of the substrate to a supporting part;
removing a coating film in the shape of a ring by a predetermined width size by supplying a solvent from a solvent nozzle to a peripheral portion of the coating film formed on the surface of the substrate while rotating the supporting part around an axis normal to the substrate;
transferring the substrate to an inspection module for inspecting a state of the coating film by imaging the entire surface of the substrate;
detecting a removal region of the coating film based on image data acquired by the inspection module; and
correcting a delivery position of a succeeding substrate with respect to the supporting part by the transfer body based on the detection result of the removal region of the coating film.

2. A method of removing a coating film of a substrate peripheral portion, comprising:
holding and supporting a circular substrate by allowing a transfer body to transfer a rear surface of the substrate to a supporting part;
removing a coating film in the shape of a ring by a predetermined width size by supplying a solvent from a solvent nozzle to a peripheral portion of the coating film formed on the surface of the substrate while rotating the supporting part around an axis normal to the substrate;
transferring the substrate to an inspection module for inspecting a state of the coating film by imaging the entire surface of the substrate;
detecting a removal region of the coating film based on image data acquired by the inspection module; and
correcting a supply position of the solvent to a succeeding substrate by the solvent nozzle based on the detection result.

3. The method of claim 1, further comprising correcting a supply position of the solvent to the succeeding substrate by the solvent nozzle based on the detection result of the removal region of the coating film.

4. The method of claim 1, further comprising determining whether to deliver the succeeding substrate from the transfer body to the supporting part of the rear surface or to stop the delivery from the transfer body to the supporting part of the rear surface based on the detection result of the removal region of the coating film.

5. The method of claim 3, wherein the correction of the delivery position of the succeeding substrate with respect to the supporting part or the correction of the supply position of the solvent to the succeeding substrate is repeatedly performed based on the detection result of the removal region, and if the number of repetitions exceeds a predetermined value, the delivery from the transfer body to the supporting part of the rear surface is stopped.

6. The method of claim 3, further comprising determining whether the state of the coating film of the substrate is good or defective based on the image data.

7. The method of claim 6, wherein the correction of the delivery position of the succeeding substrate with respect to the supporting part or the correction of the supply position of the solvent to the succeeding substrate is not based on the image data of the substrate for which the state of the coating film is determined to be defective.

8. A substrate processing apparatus, comprising:
a coating film peripheral portion removing module including a rear surface supporting part configured to hold and support a rear surface of a circular substrate having a coating film formed on a surface thereof and to rotate the substrate around an axis normal to the substrate, and a solvent supply nozzle configured to remove the coating film in the shape of a ring by a predetermined width size by supplying a solvent to a peripheral portion of the rotating substrate;
a transfer body configured to transfer the substrate to the coating film peripheral portion removing module by means of a driving mechanism and to deliver the substrate to the rear surface supporting part;
an inspection module configured to acquire image data for inspecting a state of the coating film by imaging the entire surface of the substrate having the coating film removed;
a data processing part configured to detect a removal region of the coating film based on the image data; and
a transfer body operation part configured to operate the driving mechanism to correct a delivery position of a succeeding substrate with respect to the supporting part by the transfer body based on the removal region.

9. A substrate processing apparatus, comprising:
a coating film peripheral portion removing module including a rear surface supporting part configured to hold and support a rear surface of a circular substrate having a coating film formed on a surface thereof and to rotate the substrate around an axis normal to the substrate, a solvent supply nozzle configured to remove the coating film in the shape of a ring by a predetermined width size by supplying a solvent to a peripheral portion of the rotating substrate, and a moving mechanism configured to move a supply position of the solvent between a circumferential end and an inside of the substrate;
an inspection module configured to acquire image data for inspecting a state of the coating film by imaging the entire surface of the substrate having the coating film removed;
a data processing part configured to detect a removal region of the coating film based on the image data; and
a moving mechanism operation part configured to operate the moving mechanism to correct the supply position of the solvent by the moving mechanism based on the removal region.

10. The substrate processing apparatus of claim 8, wherein the substrate processing apparatus comprises a control unit including the data processing part and the transfer body operation part, the control unit transmits a control signal to the driving mechanism to control its operation, and the control unit outputs the control signal to deliver the substrate from the transfer body to the rear surface supporting part and to deliver the succeeding substrate to the corrected delivery position based on the removal region of the coating film detected from the substrate.

11. The substrate processing apparatus of claim 10, wherein the coating film peripheral portion removing module includes a moving mechanism configured to move a supply position of the solvent between a circumferential end and an inside portion of the substrate, the control unit transmits a control signal to the moving mechanism to control its operation, and the control unit outputs the control signal to supply the solvent to the substrate and to supply the solvent to a corrected supply position based on the removal region of the coating film detected from the substrate.

12. The substrate processing apparatus of claim 10, wherein the control unit outputs a control signal to determine whether to deliver the succeeding substrate from the transfer body to the rear surface supporting part or to stop the delivery from the transfer body to the rear surface supporting part based on the detected removal region.

13. The substrate processing apparatus of claim 11, wherein the control unit outputs a control signal to repeatedly perform the correction of the delivery position of the succeeding substrate with respect to the supporting part by the transfer body or the correction of the supply position of the solvent to the succeeding substrate by the solvent nozzle based on the removal region of the coating film and stopping the delivery from the transfer body to the rear surface supporting part if the number of repetitions exceeds a predetermined value.

14. The substrate processing apparatus of claim 12, wherein the coating film peripheral portion removing module includes a first coating film peripheral portion removing module and a second coating film peripheral portion removing module, the transfer body includes a first transfer body and a second transfer body configured to transfer substrates from an upstream side module to the first coating film peripheral portion removing module and the second coating film peripheral portion removing module, respectively, the transfer of a substrate by the first transfer body and the transfer of a substrate by the second transfer body are performed in parallel with each other, and whether the substrate to be transferred from the upstream side module is transferred to the first coating film peripheral portion removing module or the second coating film peripheral portion removing module is set in advance, and wherein the control unit outputs a control signal so that when the transfer to the coating film peripheral portion removing module by any one of the first transfer body and the second transfer body is stopped, the substrates set to be transferred to the first coating film peripheral portion removing module and the second coating film peripheral portion removing module are transferred to the coating film peripheral portion removing module, which is a delivery destination of the other transfer body from the upstream side module, by the other transfer body.

15. The substrate processing apparatus of claim 8, wherein the data processing part determinates whether the state of the coating film of the substrate is good or defective based on the image data.

16. The substrate processing apparatus of claim 13, wherein the correction of the delivery position of the succeeding substrate or the correction of the supply position of the solvent is not based on the image data of the substrate for which the state of the coating film is determined to be defective.

17. A non-transitory storage medium for storing a computer program used in a substrate processing apparatus including a coating film peripheral portion removing module configured to remove a coating film of a peripheral portion of a circular substrate of a predetermined size and a transfer body configured to transfer the substrate to the coating film peripheral portion removing module,
wherein the computer program performs the method according to claim 1.

18. A non-transitory storage medium for storing a computer program used in a substrate processing apparatus including a coating film peripheral portion removing module configured to remove a coating film of a peripheral portion of a circular substrate of a predetermined size and a transfer body configured to transfer the substrate to the coating film peripheral portion removing module,
wherein the computer program performs the method according to claim 2.
